(19) United States
(12) Patent Application Publication
(10) Pub. No.: US 2025/0353973 A1
(43) Pub. Date: Nov. 20, 2025

(54) METHODS FOR THE DISPERSION PROCESSING OF HIGH ASPECT RATIO NANOMATERIALS, SUCH AS BORON NITRIDE NANOTUBES, INTO MACROSTRUCTURES

(71) Applicant: GEORGIA TECH RESEARCH CORPORATION, Atlanta, GA (US)

(72) Inventors: Casey Smith, Atlanta, GA (US); Will Gutekunst, Atlanta, GA (US)

(21) Appl. No.: 19/208,916

(22) Filed: May 15, 2025

Related U.S. Application Data
(60) Provisional application No. 63/648,640, filed on May 16, 2024.

(51) Int. Cl. C08J 3/205; C01B 21/064; C08J 5/18; C08K 3/28; C09D 7/40; C09D 7/61; C09D 7/80; C09D 177/00; D01F 6/60; D01F 9/08

(52) U.S. Cl. CPC C08J 3/205; C01B 21/0648; C08J 5/18; C09D 7/61; C09D 7/70; C09D 7/80; C09D 177/00; D01F 6/605; D01F 9/08; C01P 2002/82; C01P 2004/03; C01P 2004/13; C08J 2377/00; C08K 2003/282; C08K 2201/011

(57) ABSTRACT

The disclosed subject matter relates to methods for the dispersion processing of high aspect ratio nanomaterials, such as boron nitride nanotubes, into macrostructures. For example, the disclosed subject matter relates to boron nitride nanotube fibers and films, and methods of making and use thereof. In some examples, the methods are surfactant-free and/or sonication-free.

### CROSS-REFERENCE TO RELATED APPLICATIONS

This application claims the benefit of priority to U.S. Provisional Application No. 63/648,640 filed May 16, 2024, which is hereby incorporated herein by reference in its entirety.

### STATEMENT OF GOVERNMENT SUPPORT

This invention was made with government support under grant/contract no. 80NSSC21K2052 awarded by NASA. The government has certain rights in the invention.

### BACKGROUND

For applications in fibers and films, the scale of production, aspect ratio, and purity are important production parameters. Nanotubes and nanofibers with sufficiently high aspect ratio and purity can maintain sufficient overlap and contact to hold the structures together.

Dispersion processing of BNNTs and other high aspect ratio nanomaterials has relied on sonication and centrifugation to separate the components based on sedimentation tendencies. Sonication has been employed to disperse the BNNTs and other high aspect ratio nanomaterials before the removal of sedimented material. Costly and hazardous solvents have also been employed to improve dispersibility. However, the use of sonication and/or said solvents have various drawbacks. Improved methods that avoid the use of sonication and/or said solvents are needed. The compositions and methods discussed herein address these and other needs.

### SUMMARY

In accordance with the purposes of the disclosed compositions, devices, and methods as embodied and broadly described herein, the disclosed subject matter relates to methods for the dispersion processing of high aspect ratio nanomaterials, such as boron nitride nanotubes, into macrostructures. For example, the disclosed subject matter relates to boron nitride nanotube fibers and films, and methods of making and use thereof. In some examples, the methods are surfactant-free and/or sonication-free.

For example, disclosed herein are methods of making a high aspect ratio nanomaterial dispersion (e.g., a dispersion comprising a high aspect ratio nanomaterial), the methods comprising: dispersing the high aspect ratio nanomaterial in a first solvent, thereby forming a preliminary dispersion; and adding a second solvent to the preliminary dispersion to thereby form the high aspect ratio nanomaterial dispersion, wherein the second solvent has a higher viscosity than the first solvent and is miscible with the first solvent; wherein the first solvent and the second solvent are each independently a low-impact solvent.

In some examples, the high aspect ratio nanomaterial comprises a nanotube, such as a plurality of nanotubes.

In some examples, the high aspect ratio nanomaterial comprises boron nitride nanotubes, aramid nanofibers, or a combination thereof.

In some examples, the high aspect ratio nanomaterial comprises boron nitride nanotubes.

In some examples, the high aspect ratio nanomaterial comprises boron nitride nanotubes and aramid nanofibers.

Also disclosed herein are methods of making a boron nitride nanotube dispersion (e.g., a dispersion comprising boron nitride nanotubes), the methods comprising: dispersing a plurality of boron nitride nanotubes (BNNTs) in a first solvent, thereby forming a preliminary dispersion; and adding a second solvent to the preliminary dispersion to thereby form the boron nitride nanotube dispersion, wherein the second solvent has a higher viscosity than the first solvent and is miscible with the first solvent; wherein the first solvent and the second solvent are each independently a low-impact solvent. In some examples, the dispersion further comprises a second high aspect ratio nanomaterial. In some examples, the dispersion further comprises a plurality of aramid nanofibers.

In some examples, the first solvent comprises an alcohol. In some examples, the first solvent comprises a C1-C4 alcohol. In some examples, the first solvent comprises methanol, ethanol, n-propanol, isopropanol, n-butanol, isobutanol, sec-butanol, tert-butanol, or a combination thereof. In some examples, the first solvent comprises isopropanol.

In some examples, the second solvent comprises ethylene glycol, propylene glycol, glycerol, or a combination thereof. In some examples, the second solvent comprises glycerol.

In some examples, the first solvent comprises a C1-C4 alcohol and the second solvent comprises glycerol. In some examples, the first solvent comprises isopropanol and the second solvent comprises glycerol.

In some examples, the dispersion comprises from 1 to 99.9 vol % of the second solvent, relative to the total volume of the dispersion. In some examples, the dispersion comprises from 10 to 60 vol % of the second solvent, relative to the total volume of the dispersion. In some examples, the dispersion comprises 50 vol % or more of the second solvent, relative to the total volume of the dispersion.

In some examples, the first solvent comprises a C1-C4 alcohol, the second solvent comprises glycerol, and the dispersion comprises from 10 to 60 vol % of the second solvent, relative to the total volume of the dispersion. In some examples, the first solvent comprises isopropanol, the second solvent comprises glycerol, and the dispersion comprises from 10 to 60 vol % of the second solvent, relative to the total volume of the dispersion. In some examples, the first solvent comprises isopropanol, the second solvent comprises glycerol, and the dispersion comprises 50 vol % or more of the second solvent, relative to the total volume of the dispersion.

In some examples, the dispersion comprises from greater than 0 to 20 wt. % of the high aspect ratio nanomaterial, relative to the total weight of the dispersion. In some examples, the dispersion comprises from greater than 0 to 1 wt. % of the high aspect ratio nanomaterial, relative to the total weight of the dispersion. In some examples, the dispersion comprises from 0.001 to 0.5 wt. % of the high aspect ratio nanomaterial, relative to the total weight of the dispersion.

In some examples, the first solvent comprises isopropanol, the second solvent comprises glycerol, the dispersion comprises 50 vol % of the second solvent or more, relative to the total volume of the dispersion, and the dispersion comprises from 0.001 to 0.5 wt. % of the high aspect ratio nanomaterial.

In some examples, the high aspect ratio nanomaterial comprises a plurality of boron nitride nanotubes (BNNTs) and the dispersion comprises from greater than 0 to 20 wt. % of the BNNTs, relative to the total weight of the dispersion. In some examples, the dispersion comprises from greater than 0 to 1 wt. % of BNNTs, relative to the total weight of the dispersion. In some examples, the dispersion comprises from 0.001 to 0.5 wt. % of BNNTs, relative to the total weight of the dispersion.

In some examples, the high aspect ratio nanomaterial comprises a plurality of boron nitride nanotubes (BNNTs), the first solvent comprises isopropanol, the second solvent comprises glycerol, the dispersion comprises 50 vol % of the second solvent or more, relative to the total volume of the dispersion, and the dispersion comprises from 0.001 to 0.5 wt. % of BNNTs.

In some examples, the method, preliminary dispersion, and dispersion are substantially free of polymer surfactants.

In some examples, the method, preliminary dispersion, and dispersion are substantially free of dimethyl formamide (DMF), dimethyl acetamide (DMAc), dimethyl propylene urea (DMPU), chlorosulfonic acid (CSA), Pluronic surfactants, or a combination thereof.

In some examples, the method, preliminary dispersion, and dispersion are substantially free of dimethyl formamide (DMF), dimethyl acetamide (DMAc), dimethyl propylene urea (DMPU), Pluronic surfactants, and chlorosulfonic acid (CSA).

In some examples, the method is substantially free of sonication.

In some examples, the method minimizes the impact of sonication.

In some examples, the dispersing comprises stirring the high aspect ratio nanomaterial in the first solvent, and wherein the second solvent is subsequently added during stirring.

In some examples, the high aspect ratio nanomaterial comprises a plurality of boron nitride nanotubes and the dispersing comprises stirring the plurality of boron nitride nanotubes in the first solvent, and wherein the second solvent is subsequently added during stirring.

In some examples, the method further comprises processing the dispersion to make a macrostructure comprising the high aspect ratio nanomaterial.

In some examples, the high aspect ratio nanomaterial comprises a plurality of boron nitride nanotubes and the method further comprises processing the dispersion to make a boron nitride nanotube macrostructure (e.g., a macrostructure comprising boron nitride nanotubes).

In some examples, the macrostructure comprises a film, a fiber, a 3D printed structure, or a combination thereof.

In some examples, the macrostructure comprises a fiber. In some examples, the method further comprises spinning and/or extrusion to form the fiber. In some examples, the method further comprises extruding the dispersion through an extrusion device (e.g., syringe) into a coagulation bath to form the fiber. In some examples, the dispersion is spun using a spinneret having a diameter of 500 micrometers or less, or 410 micrometers or less, such as 60 micrometers. In some examples, the fiber has an average outer diameter of from 100 nm to 1 millimeter, from 100 nm to 100 μm, or from 10 to 25 μm. In some examples, the method further comprises drying the fiber. In some examples, the method further comprises stretching the fiber.

In some examples, the method further comprises concentrating one or more components of the dispersion prior to extrusion. In some examples, the method further comprises centrifuging the dispersion prior to extrusion.

In some examples, the macrostructure comprises a film. In some examples, the method comprises forming the film by casting, filtration, extrusion, or a combination thereof. In some examples, the method comprises filtering by applying negative pressure (e.g., vacuum). In some examples, the film has an average thickness of from 100 nanometers to 1 millimeter, from 100 nm to 100 μm, or from 5 to 10 μm. In some examples, the method further comprises drying the film. In some examples, the method further comprises stretching and/or pressing the film.

In some examples, the macrostructure comprises a 3D printed structure. In some examples, the method comprises 3D printing.

In some examples, the method further comprises drying the macrostructure.

In some examples, the method further comprises stretching and/or pressing the macrostructure.

In some examples, the method further comprises heat treating the macrostructure.

In some examples, the method further comprises removing at least a portion of the first solvent from the dispersion prior to the processing, e.g., prior to the extrusion.

In some examples, the macrostructure is stable in an oxygen environment at a temperature of 900° C. or less and/or in an inert environment at a temperature of 2000° C. or less.

In some examples, the macrostructure has a high thermal conductivity, high temperature oxidative resistance, low electrical conductivity, or a combination thereof.

Also disclosed herein are macrostructure made by any of the methods disclosed herein. In some examples, the macrostructure is free-standing and/or self-supporting.

Also disclosed herein are methods of use of any of the macrostructures disclosed herein.

Also disclosed herein are articles of manufacture comprising any of the macrostructures disclosed herein.

Additional advantages of the disclosed compositions and methods will be set forth in part in the description which follows, and in part will be obvious from the description. The advantages of the disclosed compositions and methods will be realized and attained by means of the elements and combinations particularly pointed out in the appended claims. It is to be understood that both the foregoing general description and the following detailed description are exemplary and explanatory only and are not restrictive of the disclosed compositions, devices, and methods, as claimed.

The details of one or more embodiments of the invention are set forth in the accompanying drawings and the description below. Other features, objects, and advantages of the invention will be apparent from the description and drawings, and from the claims.

### BRIEF DESCRIPTION OF THE FIGURES

The accompanying figures, which are incorporated in and constitute a part of this specification, illustrate several aspects of the disclosure, and together with the description, serve to explain the principles of the disclosure. However, the present disclosure is not limited to the precise arrangements shown, and the drawings are not necessarily drawn to scale.

FIG. 1: Same wt % BNNT dispersions with increasing vol % glycerol, left to right, 10, 20, 40, and 60 vol %; stir bar becomes increasingly translucent to indicate there is a change in the BNNT bundle size and scattering of the dispersion.

FIG. 2A-FIG. 2B: (FIG. 2A) viscosity as a function of glycerol content (FIG. 2B) refractive index as a function of C1-C4 alcohol content, data used for DLS calculation of RH.

FIG. 3A-FIG. 3F: DLS of (FIG. 3A) surfactant dispersion using Pluronic F127; comparison of surfactant dispersion to (FIG. 3B) 10 vol % glycerol, (FIG. 3C) 20 vol % glycerol, (FIG. 3D) 40 vol % glycerol, (FIG. 3E) 60 vol % glycerol, and (FIG. 3F) 90 vol % glycerol, showing decreasing bundle size exceeding the performance of the F127 surfactant dispersion at 90 vol % glycerol.

FIG. 4A-FIG. 4B: UV-vis of 60 vol % glycerol dispersion as a function of time (FIG. 4A) data showing range of wavelengths, (FIG. 4B) absorbance data at 500 nm wavelength vs time, showing the very high dispersion stability of even the 60 vol % glycerol dispersion.

FIG. 5: Rough phase diagram of BNNT content vs glycerol content in the solvent mixture, marked region shows the point where the dispersion bundle size is comparable to or lower than the surfactant-assisted dispersions from Pluronic F127.

FIG. 6: DLS data showing the impact of sonication time on the bundle size distribution of ˜100% glycerol dispersion after solvent exchange from IPA, sonication has minimal impact at high vol % glycerol, but still results in bundle size distribution reduction.

FIG. 7A-FIG. 7B: FTIR showing (FIG. 7A) little chemical change after film-making process with no sonication, (FIG. 7B) chemical functionalization of BNNTs from sonication of dispersions containing IPA—functionalization tends to increase with more IPA content.

FIG. 8A-FIG. 8B: images of BNNT fibers extruded from (FIG. 8A) 60 μm diameter syringe and (FIG. 8B) 160 μm diameter syringe; fibers maintain their shape and integrity after spinning.

FIG. 9A-FIG. 9B: SEM images of BNNT fibers from (FIG. 9A) 160 μm diameter syringe and (FIG. 9B) 60 μm diameter syringe, showing some visible local orientation imparted by shear forces during spinning.

FIG. 10: Images of folded paper airplane from BNNT buckypaper/film-making process, indicating structural integrity, flexibility, and processability.

FIG. 11A-FIG. 11D: SEM images of BNNT films showing (FIG. 11A-FIG. 11B) ˜5 μm thickness, (FIG. 11C) random alignment, and (FIG. 11D) local alignment around random nanotube placement.

FIG. 12: 0.1 wt % BNNT dispersions with increasing vol % glycerol in IPA FIG. 13A-FIG. 13F: DLS of (FIG. 13A) surfactant dispersion using Pluronic F127; compared to (FIG. 13B) 10 vol %, (FIG. 13C) 20 vol %, (FIG. 13D) 40 vol %, (FIG. 13E) 60 vol %, and (FIG. 13F) 90 vol % glycerol

FIG. 14A-FIG. 14E: images of BNNT fibers extruded from (FIG. 14A) 60 μm diameter syringe and (FIG. 14B) 160 μm diameter syringe; (FIG. 14C) successful 3D print test of BNNT dispersion; FIG. 14D) and FIG. 14E) SEM images of BNNT fibers from 60 μm diameter syringe, showing some visible local orientation

FIG. 15A-FIG. 15B: BNNT film FIG. 15A) density vs thermal diffusivity, FIG. 15B) analysis of processing effects and interactions on the thermal diffusivity

FIG. 16: HHFL BNNT film sample frontside and backside temperatures (Note: 200° C. is the pyrometer minimum; measurements of 200° C. are likely closer to room temperature)

FIG. 17A-FIG. 17D: FIG. 17A) HHFL sample after failure showing the elemental scan area for FIG. 17B) region B (center), FIG. 17C) region C, and FIG. 17D) region D (furthest from center)

FIG. 18A-FIG. 18C: FIG. 18A) 10 second on/10 second off testing regime for high heat flux laser, FIG. 18B) BNNT film above 500° C. during 10 second heat flux, FIG. 18C) BNNT film after 100 thermal cycles

FIG. 19A-FIG. 19B: HHFL 100 cycle, 20 W/cm² testing FIG. 19A) max temperature reached during each cycle, FIG. 19B) max temperature normalized against laser power for each cycle

FIG. 20A-FIG. 20B: BNNT film FIG. 20A) dielectric breakdown vs density FIG. 20B) analysis of processing effects and effect interactions on the dielectric breakdown

FIG. 21A-FIG. 21D: SEM of sample S1-G98-B0.4 after breakdown testing FIG. 21A) cross-section, FIG. 21B) conducting cavity showing, FIG. 21C) oxidized and melted boron oxide, and FIG. 21D) bridging BNNTs

FIG. 22A-FIG. 22C: BNNT film FIG. 22A) dielectric constant as a function of frequency; analysis of processing effects and effect interactions on the dielectric constant FIG. 22B) at 1 MHz, FIG. 22C) at 100 MHz

FIG. 23A-FIG. 23B: IPA/glycerol (FIG. 23A) viscosity and (FIG. 23B) refractive index as a function of glycerol

FIG. 24A-FIG. 24C: DLS data showing the impact of sonication time on the bundle size distribution of FIG. 24A) 100% DMAc dispersion, FIG. 24B) 100% IPA dispersion, and FIG. 24C) 100% glycerol dispersion content

FIG. 25: FTIR of S0-G80-B0.2 and S1-G80-B0.2 compared with as-received BNNT

FIG. 26A-FIG. 26C. FIG. 26A) spool of S1-0 ANF/BNNT fibers collected continuously, FIG. 26B) airgap spinning setup, FIG. 26C) dried fiber

FIG. 27A-FIG. 27B: SEM images of S1-0 ANF/BNNT fiber FIG. 27A) cross-section, FIG. 27B) ANF mixed with BNNTs

FIG. 28A-FIG. 28B: 51-0 ANF/BNNT fibers FIG. 28A) stress-strain curves and FIG. 28B) mechanical properties

FIG. 29A-FIG. 29D: TEM images of S1 ANF/BNNT fiber FIG. 29A) HAADF cross-section, FIG. 29B) BNNTs bridging between ANF fibrils, FIG. 29C) BNNT/ANF fibril and surrounding BNNTs, and FIG. 29D) alignment effect from ANF-BNNT confinement

FIG. 30: S2 ANF/BNNT film dielectric permittivity

FIG. 31A-FIG. 31B: FIG. 31A) cross-section of dielectric breakdown path and FIG. 31B) presence of BNNTs in cavity

FIG. 32: FTIR of ANF/BNNT fibers compared to as-received BNNT

### DETAILED DESCRIPTION

The compositions and methods described herein may be understood more readily by reference to the following detailed description of specific aspects of the disclosed subject matter and the Examples included therein.

Before the present compositions and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### General Definitions

In this specification and in the claims that follow, reference will be made to a number of terms, which shall be defined to have the following meanings.

Throughout the description and claims of this specification the word “comprise” and other forms of the word, such as “comprising” and “comprises,” means including but not limited to, and is not intended to exclude, for example, other additives, components, integers, or steps. As used in the specification and in the claims, the term “comprising” can include the aspects “consisting of” and “consisting essentially of.”

As used in the description and the appended claims, the singular forms “a,” “an,” and “the” include plural referents unless the context clearly dictates otherwise. Thus, for example, reference to “a composition” includes mixtures of two or more such compositions, reference to “an agent” includes mixtures of two or more such agents, reference to “the component” includes mixtures of two or more such components, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, a description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

When the specific values are disclosed between two end values, it is understood that these end values can also be included.

For the terms “for example” and “such as,” and grammatical equivalences thereof, the phrase “and without limitation” is understood to follow unless explicitly stated otherwise. It is further understood that these phrases are not used in a restrictive sense, but for explanatory purposes. “Exemplary” means “an example of” and is not intended to convey an indication of a preferred or ideal embodiment.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

As used herein, the term “and/or” includes any and all combinations of one or more of the associated listed items.

Values can be expressed herein as an “average” value. “Average” generally refers to the statistical mean value.

As used herein, the term “substantially” means that the subsequently described event or circumstance completely occurs or that the subsequently described event or circumstance generally, typically, or approximately occurs.

Still further, the term “substantially” can, in some aspects, refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used in the context of a composition or component of a composition that is substantially absent, is intended to refer to an amount that is then about 1% by weight, e.g., less than about 0.5% by weight, less than about 0.1% by weight, less than about 0.05% by weight, or less than about 0.01% by weight of the stated material, based on the total weight of the composition.

The expressions “ambient temperature” and “room temperature” as used herein are understood in the art and refer generally to a temperature from about 20° C. to about 35° C.

References in the specification and concluding claims to parts by weight of a particular element or component in a composition denotes the weight relationship between the element or component and any other elements or components in the composition or article for which a part by weight is expressed. Thus, in a mixture containing 2 parts by weight of component X and 5 parts by weight of component Y, components X and Y are present at a weight ratio of 2:5 and are present in such a ratio regardless of whether additional components are contained in the mixture.

A weight percent (wt. %) of a component, unless specifically stated to the contrary, is based on the total weight of the formulation or composition in which the component is included.

A volume percent (vol %) of a component, unless specifically stated to the contrary, is based on the total volume of the formulation or composition in which the component is included.

While aspects of the present invention can be described and claimed in a particular statutory class, such as the system statutory class, this is for convenience only and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to the arrangement of steps or operational flow, plain meaning derived from grammatical organization or punctuation, or the number or type of aspects described in the specification.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, Me refers to a methyl group; OMe refers to a methoxy group; and i-Pr refers to an isopropyl group.

The prefix Cₙ-Cₘ preceding a group or moiety indicates, in each case, the possible number of carbon atoms in the group or moiety that follows. For example, the term “Cₙ-Cₘ” (or “Cₙ₋ₘ”) employed alone or in combination with other terms refers to a hydrocarbon group that may be straight-chain or branched, having n to m carbons. It is understood that the terms Cₙ₋ₘ and Cₙ-Cₘ can be used interchangeably and just to show that the specific compound has between n to m carbons.

Unless otherwise defined, all technical and scientific terms used herein have the same meaning as commonly understood by one of ordinary skill in the art to which this invention belongs.

### Compositions and Methods

Disclosed herein are methods for the dispersion processing of high aspect ratio nanomaterials, such as boron nitride nanotubes, into macrostructures. For example, the disclosed subject matter relates to boron nitride nanotube fibers and films, and methods of making and use thereof. In some examples, the methods are surfactant-free and/or sonication-free.

For example, disclosed herein are methods of making a high aspect ratio nanomaterial dispersion (e.g., a dispersion comprising a high aspect ratio nanomaterial). As used herein, “aspect ratio” refers to the length divided by outer cross-sectional dimension (e.g., outer diameter). A high aspect ratio, for example, can be an aspect ratio greater than 1 (e.g., 5 or more, 10 or more, 50 or more, 100 or more, 500 or more, 1×10³ or more, 5×10³ or more, 1×10⁴ or more, 5×10⁴ or more, 1×10⁵ or more, 5×10⁵ or more, 1×10⁶ or more, or 5×10⁶ or more). Examples of high aspect ratio nanomaterials include, but are not limited to, nanotubes, nanowires, nanofibers, and combinations thereof.

As used herein, “a nanotube” and “the nanotube” are meant to include any number of nanotubes. Thus, for example “a nanotube” includes one or more nanotubes. In some embodiments, the nanotube can comprise a plurality of nanotubes. As used herein, the term “nanotube” refers to an elongated tubular or cylindrical structure. Similarly, “a nanowire” and “the nanowire” are meant to include any number of nanowires, and “a nanofiber” and “the nanofiber” are meant to include any number of nanofibers.

For example, the methods can comprise dispersing the high aspect ratio nanomaterial in a first solvent, thereby forming a preliminary dispersion; and adding a second solvent to the preliminary dispersion to thereby form the high aspect ratio nanomaterial dispersion, wherein the second solvent has a higher viscosity than the first solvent and is miscible with the first solvent; wherein the first solvent and the second solvent are each independently a low-impact solvent.

In some examples, the high aspect ratio nanomaterial comprises a nanotube, such as a plurality of nanotubes. For example, the methods can comprise dispersing a plurality of nanotubes in a first solvent, thereby forming a preliminary dispersion; and adding a second solvent to the preliminary dispersion to thereby form the boron nitride nanotube dispersion, wherein the second solvent has a higher viscosity than the first solvent and is miscible with the first solvent; wherein the first solvent and the second solvent are each independently a low-impact solvent.

The nanomaterial can comprise any suitable material compatible with the methods disclosed herein. For example, the nanomaterial can comprise boron nitride, graphene, silicon, aramid, or a combination thereof.

For example, the high aspect ratio nanomaterial can comprise boron nitride nanotubes, aramid nanofibers, silicon nanotubes, carbon nanotubes, or a combination thereof.

In some examples, the high aspect ratio nanomaterial comprises boron nitride nanotubes, aramid nanofibers, or a combination thereof. In some examples, the high aspect ratio nanomaterial comprises boron nitride nanotubes. In some examples, the high aspect ratio nanomaterial comprises aramid nanofibers. In some examples, the high aspect ratio nanomaterial comprises boron nitride nanotubes and aramid nanofibers.

In some examples, the high aspect ratio nanomaterial comprises boron nitride nanotubes. For example, also disclosed herein are methods of making a boron nitride nanotube dispersion (e.g., a dispersion comprising boron nitride nanotubes).

As used herein, “a boron nitride nanotube” and “the boron nitride nanotube” are meant to include any number of boron nitride nanotubes. Thus, for example “a boron nitride nanotube” includes one or more boron nitride nanotubes. In some embodiments, the boron nitride nanotube can comprise a plurality of boron nitride nanotubes. As used herein, the term “boron nitride nanotube” or “BNNT” refers to an elongated tubular or cylindrical structure comprising boron nitride.

For example, the methods can comprise dispersing a plurality of boron nitride nanotubes (BNNTs) in a first solvent, thereby forming a preliminary dispersion; and adding a second solvent to the preliminary dispersion to thereby form the boron nitride nanotube dispersion, wherein the second solvent has a higher viscosity than the first solvent and is miscible with the first solvent; wherein the first solvent and the second solvent are each independently a low-impact solvent.

As used herein a “low-impact solvent” is a solvent that has relatively minimal impact (e.g., minimal hazardous impact) to people, animals, and/or equipment, and/or is relatively environmentally friendly. Examples of low-impact solvents include, but are not limited to, water, supercritical carbon dioxide, alcohols, esters, glycerol, glycols, fatty acid esters, terpenes, ionic liquids, and combinations thereof.

In some examples, the first solvent comprises an alcohol. In some examples, the first solvent comprises a C1-C4 alcohol. In some examples, the first solvent comprises methanol, ethanol, propanol, isopropanol, butanol, or a combination thereof. In some examples, the first solvent comprises methanol, ethanol, n-propanol, isopropanol, n-butanol, isobutanol, sec-butanol, tert-butanol, or a combination thereof. In some examples, the first solvent comprises isopropanol.

In some examples, the second solvent comprises ethylene glycol, propylene glycol, glycerol, or a combination thereof. In some examples, the second solvent comprises glycerol.

In some examples, the first solvent comprises a C1-C4 alcohol and the second solvent comprises glycerol. In some examples, the first solvent comprises isopropanol and the second solvent comprises glycerol.

In some examples, the dispersion comprises 1 vol % or more of the second solvent relative to the total volume of the dispersion (e.g., 2 vol % or more, 3 vol % or more, 4 vol % or more, 5 vol % or more, 10 vol % or more, 15 vol % or more, 20 vol % or more, 25 vol % or more, 30 vol % or more, 35 vol % or more, 40 vol % or more, 45 vol % or more, 50 vol % or more, 55 vol % or more, 60 vol % or more, 65 vol % or more, 70 vol % or more, 75 vol % or more, 80 vol % or more, 85 vol % or more, 90 vol % or more, 95 vol % or more, or 99 vol % or more). In some examples, the dispersion comprises 99.9 vol % or less of the second solvent relative to the total volume of the dispersion (e.g., 95 vol % or less, 90 vol % or less, 85 vol % or less, 80 vol % or less, 75 vol % or less, 70 vol % or less, 65 vol % or less, 60 vol % or less, 55 vol % or less, 50 vol % or less, 45 vol % or less, 40 vol % or less, 35 vol % or less, 30 vol % or less, 25 vol % or less, 20 vol % or less, 15 vol % or less, 10 vol % or less, or 5 vol % or less). The volume of the second solvent in the dispersion can range from any of the minimum values described above to any of the maximum values described above. For example, the dispersion can comprise from 1 to 99.9 vol % of the second solvent, relative to the total volume of the dispersion (e.g., from 1 to 50 vol %, from 50 to 99.9 vol %, from 1 to 25 vol %, from 25 to 50 vol %, from 50 to 75 vol %, from 75 to 99.9 vol %, from 1 to 90 vol %, 10 to 99.9 vol %, from 20 to 99.9 vol %, from 30 to 99.9 vol %, from 40 to 99.9 vol %, from 50 to 99.9 vol %, from 60 to 99.9 vol %, from 80 to 99.9 vol %, from 80 to 98 vol %, from 10 to 90 vol %, from 10 to 80 vol %, or from 10 to 60 vol %). In some examples, the dispersion comprises from 10 to 60 vol % of the second solvent, relative to the total volume of the dispersion. In some examples, the dispersion comprises 50 vol % or more of the second solvent, relative to the total volume of the dispersion. In some examples, the dispersion comprises from 80 to 98 vol % of the second solvent, relative to the total volume of the dispersion.

In some examples, the first solvent comprises a C1-C4 alcohol, the second solvent comprises glycerol, and the dispersion comprises from 10 to 60 vol % of the second solvent, relative to the total volume of the dispersion. In some examples, the first solvent comprises isopropanol, the second solvent comprises glycerol, and the dispersion comprises from 10 to 60 vol % of the second solvent, relative to the total volume of the dispersion. In some examples, the first solvent comprises isopropanol, the second solvent comprises glycerol, and the dispersion comprises 50 vol % or more of the second solvent, relative to the total volume of the dispersion.

In some examples, the dispersion comprises greater than 0 wt. % of the high aspect ratio nanomaterial, relative to the total weight of the dispersion (e.g., 0.001 wt. % or more, 0.002 wt. % or more, 0.003 wt. % or more, 0.004 wt. % or more, 0.005 wt. % or more, 0.01 wt. % or more, 0.015 wt. % or more, 0.02 wt. % or more, 0.025 wt. % or more, 0.05 wt. % or more, 0.075 wt. % or more, 0.1 wt. % or more, 0.15 wt. % or more, 0.2 wt. % or more, 0.25 wt. % or more, 0.3 wt. % or more, 0.35 wt. % or more, 0.4 wt. % or more, 0.45 wt. % or more, 0.5 wt. % or more, 0.6 wt. % or more, 0.7 wt. % or more, 0.8 wt. % or more, 0.9 wt. % or more, 1 wt. % or more, 1.25 wt. % or more, 1.5 wt. % or more, 1.75 wt. % or more, 2 wt. % or more, 2.25 wt. % or more, 2.5 wt. % or more, 3 wt. % or more, 3.5 wt. % or more, 4 wt. % or more, 4.5 wt. % or more, 5 wt. % or more, 6 wt. % or more, 7 wt. % or more, 8 wt. % or more, 9 wt. % or more, 10 wt. % or more, 11 wt. % or more, 12 wt. % or more, 13 wt. % or more, 14 wt. % or more, 15 wt. % or more, 16 wt. % or more, 17 wt. % or more, 18 wt. % or more, or 19 wt. % or more). In some examples, the dispersion comprises 20 wt. % or less of the high aspect ratio nanomaterial, relative to the total weight of the dispersion (e.g., 19 wt. % or less, 18 wt. % or less, 17 wt. % or less, 16 wt. % or less, 15 wt. % or less, 14 wt. % or less, 13 wt. % or less, 12 wt. % or less, 11 wt. % or less, 10 wt. % or less, 9 wt. % or less, 8 wt. % or less, 7 wt. % or less, 6 wt. % or less, 5 wt. % or less, 4.5 wt. % or less, 4 wt. % or less, 3.5 wt. % or less, 3 wt. % or less, 2.5 wt. % or less, 2.25 wt. % or less, 2 wt. % or less, 1.75 wt. % or less, 1.5 wt. % or less, 1.25 wt. % or less, 1 wt. % or less, 0.9 wt. % or less, 0.8 wt. % or less, 0.7 wt. % or less, 0.6 wt. % or less, 0.5 wt. % or less, 0.45 wt. % or less, 0.4 wt. % or less, 0.35 wt. % or less, 0.3 wt. % or less, 0.25 wt. % or less, 0.2 wt. % or less, 0.15 wt. % or less, 0.1 wt. % or less, 0.075 wt. % or less, 0.05 wt. % or less, 0.025 wt. % or less, 0.02 wt. % or less, 0.015 wt. % or less, 0.01 wt. % or less, or 0.005 wt. % or less). The amount of the high aspect ratio nanomaterial in the dispersion can range from any of the minimum values described above to any of the maximum values described above. For example, the dispersion can comprise from greater than 0 to 20 wt. % of the high aspect ratio nanomaterial, relative to the total weight of the dispersion (e.g., from greater than 0 to 10 wt. %, from 10 to 20 wt. %, from greater than 0 to 5 wt. %, from 5 to 10 wt. %, from 10 to 15 wt. %, from 15 to 20 wt. %, from greater than 0 to 15 wt. %, from greater than 0 to 1 wt. %, from 0.001 to 20 wt. %, from 0.001 to 15 wt. %, from 0.001 to 10 wt. %, from 0.001 to 5 wt. %, from 0.001 to 1 wt. %, from 0.001 to 0.5 wt. %, from 0.1 to 20 wt. %, from 0.1 to 15 wt. %, from 0.1 to 10 wt. %, from 0.1 to 5 wt. %, from 0.1 to 1 wt. %, from 0.1 to 0.5 wt. %, or from 0.1 to 0.4 wt. %). In some examples, the dispersion comprises from greater than 0 to 1 wt. % of the high aspect ratio nanomaterial, relative to the total weight of the dispersion. In some examples, the dispersion comprises from 0.001 to 0.5 wt. % of the high aspect ratio nanomaterial, relative to the total weight of the dispersion.

In some examples, the first solvent comprises isopropanol, the second solvent comprises glycerol, the dispersion comprises 50 vol % of the second solvent or more, relative to the total volume of the dispersion, and the dispersion comprises from 0.001 to 0.5 wt. % of the high aspect ratio nanomaterial.

In some examples, the high aspect ratio nanomaterial comprises BNNTs and dispersion comprises greater than 0 wt. % BNNTs, relative to the total weight of the dispersion (e.g., 0.001 wt. % or more, 0.002 wt. % or more, 0.003 wt. % or more, 0.004 wt. % or more, 0.005 wt. % or more, 0.01 wt. % or more, 0.015 wt. % or more, 0.02 wt. % or more, 0.025 wt. % or more, 0.05 wt. % or more, 0.075 wt. % or more, 0.1 wt. % or more, 0.15 wt. % or more, 0.2 wt. % or more, 0.25 wt. % or more, 0.3 wt. % or more, 0.35 wt. % or more, 0.4 wt. % or more, 0.45 wt. % or more, 0.5 wt. % or more, 0.6 wt. % or more, 0.7 wt. % or more, 0.8 wt. % or more, 0.9 wt. % or more, 1 wt. % or more, 1.25 wt. % or more, 1.5 wt. % or more, 1.75 wt. % or more, 2 wt. % or more, 2.25 wt. % or more, 2.5 wt. % or more, 3 wt. % or more, 3.5 wt. % or more, 4 wt. % or more, 4.5 wt. % or more, 5 wt. % or more, 6 wt. % or more, 7 wt. % or more, 8 wt. % or more, 9 wt. % or more, 10 wt. % or more, 11 wt. % or more, 12 wt. % or more, 13 wt. % or more, 14 wt. % or more, 15 wt. % or more, 16 wt. % or more, 17 wt. % or more, 18 wt. % or more, or 19 wt. % or more). In some examples, the dispersion comprises 20 wt. % or less BNNTs, relative to the total weight of the dispersion (e.g., 19 wt. % or less, 18 wt. % or less, 17 wt. % or less, 16 wt. % or less, 15 wt. % or less, 14 wt. % or less, 13 wt. % or less, 12 wt. % or less, 11 wt. % or less, 10 wt. % or less, 9 wt. % or less, 8 wt. % or less, 7 wt. % or less, 6 wt. % or less, 5 wt. % or less, 4.5 wt. % or less, 4 wt. % or less, 3.5 wt. % or less, 3 wt. % or less, 2.5 wt. % or less, 2.25 wt. % or less, 2 wt. % or less, 1.75 wt. % or less, 1.5 wt. % or less, 1.25 wt. % or less, 1 wt. % or less, 0.9 wt. % or less, 0.8 wt. % or less, 0.7 wt. % or less, 0.6 wt. % or less, 0.5 wt. % or less, 0.45 wt. % or less, 0.4 wt. % or less, 0.35 wt. % or less, 0.3 wt. % or less, 0.25 wt. % or less, 0.2 wt. % or less, 0.15 wt. % or less, 0.1 wt. % or less, 0.075 wt. % or less, 0.05 wt. % or less, 0.025 wt. % or less, 0.02 wt. % or less, 0.015 wt. % or less, 0.01 wt. % or less, or 0.005 wt. % or less). The amount of BNNTs in the dispersion can range from any of the minimum values described above to any of the maximum values described above. For example, the dispersion can comprise from greater than 0 to 20 wt. % BNNTs, relative to the total weight of the dispersion (e.g., from greater than 0 to 10 wt. %, from 10 to 20 wt. %, from greater than 0 to 5 wt. %, from 5 to 10 wt. %, from 10 to 15 wt. %, from 15 to 20 wt. %, from greater than 0 to 15 wt. %, from greater than 0 to 1 wt. %, from 0.001 to 20 wt. %, from 0.001 to 15 wt. %, from 0.001 to 10 wt. %, from 0.001 to 5 wt. %, from 0.001 to 1 wt. %, from 0.001 to 0.5 wt. %, from 0.1 to 20 wt. %, from 0.1 to 15 wt. %, from 0.1 to 10 wt. %, from 0.1 to 5 wt. %, from 0.1 to 1 wt. %, from 0.1 to 0.5 wt. %, or from 0.1 to 0.4 wt. %). In some examples, the dispersion comprises from greater than 0 to 1 wt. % of BNNTs, relative to the total weight of the dispersion. In some examples, the dispersion comprises from 0.001 to 0.5 wt. % of BNNTs, relative to the total weight of the dispersion.

In some examples, the first solvent comprises isopropanol, the second solvent comprises glycerol, the dispersion comprises 50 vol % of the second solvent or more, relative to the total volume of the dispersion, and the dispersion comprises from 0.001 to 0.5 wt. % of BNNTs.

In some examples, the method, preliminary dispersion, and dispersion are substantially free of polymer surfactants.

In some examples, the method, preliminary dispersion, and dispersion are substantially free of dimethyl formamide (DMF), dimethyl acetamide (DMAc), dimethyl propylene urea (DMPU), chlorosulfonic acid (CSA), Pluronic surfactants, or a combination thereof.

In some examples, the method, preliminary dispersion, and dispersion are substantially free of dimethyl formamide (DMF), dimethyl acetamide (DMAc), dimethyl propylene urea (DMPU), Pluronic surfactants, and chlorosulfonic acid (CSA).

In some examples, the method is substantially free of sonication (e.g., the method does not include sonication).

In some examples, the method minimizes the impact of sonication (e.g., minimized the damage caused by sonication on the high aspect ratio nanomaterial and/or the effectiveness of sonication on dispersing the high aspect ratio nanomaterial).

In some examples, the dispersing comprises stirring the high aspect ratio nanomaterial in the first solvent, and wherein the second solvent is subsequently added during stirring. In some examples, the high aspect ratio nanomaterial comprises a plurality of boron nitride nanotubes and the dispersing comprises stirring the plurality of boron nitride nanotubes in the first solvent, and wherein the second solvent is subsequently added during stirring.

In some examples, the method further comprises processing the dispersion to make a macrostructure comprising the high aspect ratio nanomaterial. In some examples, the high aspect ratio nanomaterial comprises boron nitride nanotubes and the method further comprises processing the dispersion to make a boron nitride nanotube macrostructure (e.g., a macrostructure comprising boron nitride nanotubes).

In some examples, the macrostructure comprises a film, a fiber, a 3D printed structure, or a combination thereof. In some examples, the macrostructure is free-standing and/or self-supporting.

In some examples, the macrostructure comprises a fiber.

In some examples, the method further comprises spinning and/or extrusion to form the fiber. In some examples, spinning the mixture (or extruding) comprises electrospinning, wet jet fiber pulling, wet spinning, dry spinning, dry-jet wet spinning, or combinations thereof. In some examples, spinning the mixture comprises dry-jet wet spinning.

In some examples, the method further comprises extruding the dispersion through an extrusion device (e.g., syringe) into a coagulation bath to form the fiber. The coagulation bath comprises a coagulation solvent. The coagulation solvent can comprise any suitable solvent. Examples of suitable solvents include, but are not limited to, methanol, methanol:deionized water (DIW), DIW, acetone, isopropanol (IPA).

In some examples, the dispersion is spun using a spinneret having a diameter of 2 millimeters or less (e.g., 1.75 millimeters or less, 1.5 millimeters or less, 1.25 millimeters or less, 1 millimeter or less, 900 micrometers (m) or less, 800 μm or less, 700 μm or less, 600 μm or less, 500 μm or less, 450 μm or less, 400 μm or less, 350 μm or less, 300 μm or less, 250 μm or less, 225 μm or less, 200 μm or less, 175 μm or less, 150 μm or less, 125 μm or less, 100 μm or less, 75 μm or less, 50 μm or less, 40 μm or less, 30 μm or less, or 20 μm or less). In some examples, the dispersion is spun using a spinneret having a diameter of 10 μm or more (e.g., 20 μm or more, 30 μm or more, 40 μm or more, 50 μm or more, 75 μm or more, 100 μm or more, 125 μm or more, 150 μm or more, 175 μm or more, 200 μm or more, 225 μm or more, 250 μm or more, 300 μm or more, 350 μm or more, 400 μm or more, 450 μm or more, 500 μm or more, 600 μm or more, 700 μm or more, 800 μm or more, 900 μm or more, 1 millimeter or more, 1.25 millimeters or more, or 1.5 millimeters or more). The average diameter of the spinneret can range from any of the minimum values described above to any of the maximum values described above. For example, the dispersion can be spun using a spinneret having a diameter of from 10 micrometers to 2 millimeters (e.g., from 10 micrometers to 100 micrometers, from 100 micrometers to 1 millimeter, from 1 millimeters to 2 millimeters, from 10 micrometers to 500 micrometers, from 500 micrometers to 1 millimeter, from 1 millimeter to 1.5 millimeters, from 1.5 millimeters to 2 millimeters, from 10 micrometers to 1.5 millimeters, from 50 micrometers to 2 millimeters, or from 50 micrometers to 1.5 millimeters). In some examples, the dispersion can be spun using a spinneret having a diameter of from 10 μm to 500 μm (e.g., from 10 μm to 250 μm, from 250 μm to 500 μm, from 10 μm to 100 μm, from 100 μm to 200 μm, from 200 μm to 300 μm, from 300 μm to 400 μm, from 400 μm to 500 μm, from 10 μm to 400 am, from 10 μm to 300 μm, from 10 μm to 200 μm, from 10 μm to 100 am, from 25 μm to 500 μm, from 50 μm to 500 μm, from 100 am to 500 μm, from 200 μm to 500 μm, from 300 μm to 500 am, from 25 μm to 450 μm, or from 50 μm to 500 μm). In some examples, the dispersion can be spun using a spinneret having a diameter of 500 micrometers or less, or 410 micrometers or less, such as 60 micrometers.

In some examples, the method further comprises concentrating on or more components of the dispersion prior to extrusion, for example to increase the volume fraction of the first and/or second solvent and/or to increase the weight fraction of the high aspect ratio nanomaterial in the dispersion. Methods of concentrating the dispersion include, but are not limited to, distillation, centrifugation, evaporation, decanting, and combinations thereof.

In some examples, the method further comprises centrifuging the dispersion prior to extrusion.

In some examples, the fiber has an average outer diameter of 100 nanometers (nm) or more (e.g., 150 nm or more, 200 nm or more, 250 nm or more, 300 nm or more, 400 nm or more, 500 nm or more, 750 nm or more, 1 micrometer (μm) or more, 1.25 μm or more, 1.5 μm or more, 2 μm or more, 2.5 μm or more, 3 μm or more, 3.5 μm or more, 4 μm or more, 4.5 μm or more, 5 μm or more, 6 μm or more, 7 μm or more, 8 μm or more, 9 μm or more, 10 μm or more, 15 μm or more, 20 μm or more, 25 μm or more, 30 μm or more, 40 μm or more, 50 μm or more, 75 μm or more, 100 μm or more, 125 μm or more, 150 μm or more, 200 μm or more, 250 μm or more, 300 μm or more, 400 μm or more, 500 μm or more, 600 μm or more, 700 μm or more, 800 μm or more, or 900 μm or more). In some examples, the fiber has an average outer diameter of 1 millimeter or less (e.g., 900 micrometers (μm) or less, 800 μm or less, 700 μm or less, 600 μm or less, 500 μm or less, 400 μm or less, 300 μm or less, 250 μm or less, 200 μm or less, 150 μm or less, 125 μm or less, 100 μm or less, 75 μm or less, 50 μm or less, 40 μm or less, 30 μm or less, 25 μm or less, 20 μm or less, 15 μm or less, 10 μm or less, 9 μm or less, 8 μm or less, 7 μm or less, 6 μm or less, 5 μm or less, 4.5 μm or less, 4 μm or less, 3.5 μm or less, 3 μm or less, 2.5 μm or less, 2 μm or less, 1.5 μm or less, 1.25 μm or less, 1 μm or less, 750 nanometers (nm) or less, 500 nm or less, 400 nm or less, 300 nm or less, 250 nm or less, 200 nm or less, or 150 nm or less). The average outer diameter of the fiber can range from any of the minimum values described above to any of the maximum values described above. For example, the fiber can have an average outer diameter of from 100 nanometers (nm) to 1 millimeter (mm) (e.g., from 100 nm to 50 μm, 50 μm to 1 mm, from 100 nm to 1 μm, from 1 μm to 10 μm, from 10 μm to 100 μm, from 100 μm to 1 mm, from 100 nm to 500 μm, from 100 nm to 100 μm, from 100 nm to 50 μm, from 100 nm to 10 μm, from 100 nm to 1 μm, from 500 nm to 1 mm, from 1 μm to 1 mm, from 10 μm to 1 mm, from 50 μm to 1 mm, from 100 μm to 1 mm, from 150 nm to 1.5 mm, from 100 nm to 100 μm, from 1 μm to 100 μm, from 10 μm to 50 μm, or from 10 μm to 25 μm). In some examples, the fiber has an average outer diameter of from 100 nm to 100 μm. In some examples, the fiber can have an average outer diameter of from 10 to 25 μm.

In some examples, the method further comprises drying the fiber.

In some examples, the method further comprises stretching the fiber.

In some examples, the macrostructure comprises a film.

In some examples, the method comprises forming the film by casting, filtration, extrusion, or a combination thereof. In some examples, the method comprises filtering by applying negative pressure (e.g., vacuum).

In some examples, the film has an average thickness of 100 nanometers (nm) or more (e.g., 150 nm or more, 200 nm or more, 250 nm or more, 300 nm or more, 400 nm or more, 500 nm or more, 750 nm or more, 1 micrometer (μm) or more, 1.25 μm or more, 1.5 μm or more, 2 μm or more, 2.5 μm or more, 3 μm or more, 3.5 μm or more, 4 μm or more, 4.5 μm or more, 5 μm or more, 6 μm or more, 7 μm or more, 8 μm or more, 9 μm or more, 10 μm or more, 15 μm or more, 20 μm or more, 25 μm or more, 30 μm or more, 40 μm or more, 50 μm or more, 75 μm or more, 100 μm or more, 125 μm or more, 150 μm or more, 200 μm or more, 250 μm or more, 300 μm or more, 400 μm or more, 500 μm or more, 600 μm or more, 700 μm or more, 800 μm or more, or 900 μm or more). In some examples, the film has an average thickness of 1 millimeter or less (e.g., 900 micrometers (μm) or less, 800 μm or less, 700 μm or less, 600 μm or less, 500 μm or less, 400 μm or less, 300 μm or less, 250 μm or less, 200 μm or less, 150 μm or less, 125 μm or less, 100 μm or less, 75 μm or less, 50 μm or less, 40 μm or less, 30 μm or less, 25 μm or less, 20 μm or less, 15 μm or less, 10 μm or less, 9 μm or less, 8 μm or less, 7 μm or less, 6 μm or less, 5 μm or less, 4.5 μm or less, 4 μm or less, 3.5 μm or less, 3 μm or less, 2.5 μm or less, 2 μm or less, 1.5 μm or less, 1.25 μm or less, 1 μm or less, 750 nanometers (nm) or less, 500 nm or less, 400 nm or less, 300 nm or less, 250 nm or less, 200 nm or less, or 150 nm or less). The average thickness of the film can range from any of the minimum values described above to any of the maximum values described above. For example, the film can have an average thickness of from 100 nanometers (nm) to 1 millimeter (mm) (e.g., from 100 nm to 50 μm, 50 μm to 1 mm, from 100 nm to 1 μm, from 1 μm to 10 μm, from 10 μm to 100 μm, from 100 μm to 1 mm, from 100 nm to 500 μm, from 100 nm to 100 μm, from 100 nm to 50 μm, from 100 nm to 10 μm, from 100 nm to 1 μm, from 500 nm to 1 mm, from 1 μm to 1 mm, from 10 μm to 1 mm, from 50 μm to 1 mm, from 100 μm to 1 mm, from 150 nm to 1.5 mm, from 100 nm to 100 μm, from 1 μm to 100 μm, from 1 μm to 50 μm, from 1 μm to 25 μm, or from 5 to 10 μm). In some examples, the film has an average thickness of from 100 nm to 100 μm. In some examples, the film has an average thickness of from 5 to 10 μm.

In some examples, the method further comprises drying the film.

In some examples, the method further comprises stretching and/or pressing the film.

In some examples, the macrostructure comprises a 3D printed structure. In some examples, the method comprises 3D printing.

In some examples, the method further comprises drying the macrostructure.

In some examples, the method further comprises stretching and/or pressing the macrostructure.

In some examples, the method further comprises heat treating the macrostructure. Heat treating the macrostructure can, for example, comprise heating the macrostructure at a temperature of 700° C. or more in an inert environment (e.g., 750° C. or more, 800° C. or more, 850° C. or more, 900° C. or more, 950° C. or more, 1000° C. or more, 1050° C. or more, 1100° C. or more, 1150° C. or more, 1200° C. or more, 1250° C. or more, 1300° C. or more, 1350° C. or more, 1400° C. or more, 1450° C. or more, 1500° C. or more, 1550° C. or more, 1600° C. or more, 1650° C. or more, 1700° C. or more, 1750° C. or more, 1800° C. or more, 1850° C. or more, 1900° C. or more, or 1950° C. or more). In some examples, heat treating the macrostructure can comprise heating the composite fiber at a temperature of 2000° C. or less in an inert environment (e.g., 1950° C. or less, 1900° C. or less, 1850° C. or less, 1800° C. or less, 1750° C. or less, 1700° C. or less, 1650° C. or less, 1600° C. or less, 1550° C. or less, 1500° C. or less, 1450° C. or less, 1400° C. or less, 1350° C. or less, 1300° C. or less, 1250° C. or less, 1200° C. or less, 1150° C. or less, 1100° C. or less, 1050° C. or less, 1000° C. or less, 950° C. or less, 900° C. or less, 850° C. or less, 800° C. or less, or 750° C. or less). The temperature at which the macrostructure is heat treated can range from any of the minimum values described above to any of the maximum values described above. For example, heat treating the macrostructure can comprise heating the macrostructure at a temperature of from 700° C. to 2000° C. (e.g., from 700° C. to 1350° C., from 1350° C. to 2000° C., from 700° C. to 1100° C., from 1100° C. to 1500° C., from 1500° C. to 2000° C., 800° C. to 2000° C., from 700° C. to 1900° C., or from 800° C. to 1900° C.). In some examples, heat treating the macrostructure can comprise heating the macrostructure at a temperature of from 1500° C. to 2000° C. in an inert environment 15 (e.g., from 1500° C. to 1750° C., from 1750° C. to 2000° C., from 1500° C. to 1600° C., from 1600° C. to 1700° C., from 1700° C. to 1800° C., from 1800° C. to 1900° C., from 1900° C. to 2000° C., from 1500° C. to 1900° C., from 1500° C. to 1800° C., from 1500° C. to 1700° C., from 1600° C. to 2000° C., from 1700° C. to 2000° C., from 1800° C. to 2000° C., or from 1550° C. to 1950° C.).

In some examples, the method further comprises removing at least a portion of the first solvent from the dispersion prior to the processing, e.g., prior to the extrusion.

In some examples, the macrostructure is stable in an oxygen environment at a temperature of 900° C. or less and/or in an inert environment at a temperature of 2000° C. or less.

In some examples, the macrostructure has a high thermal conductivity, high temperature oxidative resistance, low electrical conductivity, or a combination thereof.

Also disclosed herein are the macrostructures made by any of the methods disclosed herein. In some examples, the macrostructure is free-standing and/or self-supporting.

Also disclosed herein are methods of use of any of the macrostructures disclosed herein.

Also disclosed herein are articles of manufacture comprising any of the macrostructures disclosed herein.

A number of embodiments of the invention have been described. Nevertheless, it will be understood that various modifications may be made without departing from the spirit and scope of the invention. Accordingly, other embodiments are within the scope of the following claims.

The examples below are intended to further illustrate certain aspects of the systems and methods described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of measurement conditions, e.g., component concentrations, temperatures, pressures and other measurement ranges and conditions that can be used to optimize the described process.

### Example 1—A Surfactant- and Sonication-Free Method for the Dispersion Processing of Boron Nitride Nanotubes into Macrostructures

Disclosed herein is a method to process boron nitride nanotubes (BNNTs) from alcohol dispersions into macrostructures such as fibers and films. BNNTs are dispersed in a solvent that wets the BNNTs (such as C1-C4 alcohols), then a second miscible solvent with higher viscosity (such as glycerol) is added. The first dispersion step offers an initial dispersion, but this single solvent dispersion is not easily processable. These initial dispersions contain high amounts of large entangled bundles that do not pack well. The second dispersion step involves the addition of a more viscous, miscible solvent to increase the solvent mix viscosity and form a favorable mix morphology. The dispersion from the binary solvent mixture shows significantly lower nanotube bundle sizes, allowing for processing into higher performance macrostructures.

An example of the innovative nature of methods described herein is that an example dispersion of the first step alone could not be extruded through a syringe of <410 μm diameter without clogging, whereas the dispersion after the second step could be continuously extruded through a syringe of 60 μm diameter without issue. This improvement can be due to the higher viscosity and dispersion quality after the second step; the dispersion after the first step tends to entangle and clog upon applying shear whereas the dispersion after the second step undergoes alignment and disentanglement under shear force. The methods described herein, therefore, allows these dispersions to be processed at two orders of magnitude higher shear stresses, increasing alignment and performance of the resultant macrostructure. Additionally, the methods described herein can be performed without the use of polymer surfactants or sonication, both of which have an impact on the chemistry or mechanical performance of the final structure.

Two examples of macrostructures created using the dispersion methods described herein are BNNT fibers and films (sometimes called buckypaper). For fiber processing, the solvent mix BNNT dispersions are concentrated with centrifugation, where the time and g-level of centrifugation offer precise controls over the dispersion BNNT wt % and viscosity. Fibers are then spun by extrusion of the concentrated solution through a spinneret and into a bath that removes the mixed solvents and later evaporates to leave only nanotube fibers. These fibers have good mechanical integrity and can be stretched to increase properties and alignment. For film processing, the solvent mix BNNT dispersions are left dilute and processed into films using a variety of processes, including casting, filtration, and extrusion. These films have undergone structural and elemental analysis to verify that they maintain their original composition. These fibers and films can be useful for applications where thermal conductivity and electrical insulation is desired. Boron nitride is a known electrical insulator, and highly aligned nanotubes can offer thermal conductivity up to 500 W/mK (˜2× the thermal conductivity of aluminum). Additionally, these fibers and films have high temperature applications and are viable in applications where the material processing conditions are conducted at high temperature (e.g. metallurgy). These fibers and films are stable in oxygen up to 900° C. and stable in inert environments up to 2000° C. Further optimization of these processing conditions can further increase mechanical and thermal performance.

The method employs insulative materials (boron nitride) in a structure of moderate alignment that increases the thermal conductivity of the structure, e.g., to makes application in semiconductor heat management, high temperature heat management in vehicles, ablative structures, and low-k dielectric material applications.

The exemplary material processing methodology can use benign solvents and avoid the use of polymer surfactants and sonication. Good dispersions of BNNTs have largely been recorded with solvents such as DMF, DMAc, DMPU, and CSA, which have their own safety and handling issues that increase costs and danger to personnel. C1-C4 alcohols and glycerol are cheaper and offer relatively little exposure issues when compared to the other solvents previously used. The method herein thus represent a large step forward in developing cheaper and safer methods to process nanotubes using solvents.

Additionally, polymer surfactants have been used elsewhere to improve dispersion quality, but the presence of polymer causes contamination that is harmful for most applications. Also, it is difficult to remove all of the polymer, mostly leaving <5 wt % of carbon contamination that can lower performance of a dielectric material with intended use in heat management. Sonication degrades the length of the nanotubes and can cause defects to form on the walls, also degrading performance. Macrostructures of nanotubes benefit from their high aspect ratio (length/diameter), so degradation of the length reduces the aspect ratio and can lower mechanical properties. The method described herein was developed to avoid the most prominent issues associated with wet processing of nanotubes, and it appears to do this quite successfully.

The methods described herein can overcome limitations associated with expensive, hazardous solvent use as well as surfactant and sonication use in the processing of nanotube macrostructures. The method can be extremely straightforward and inexpensive, requiring only solvents, a mixer, a centrifuge, and syringe (for fibers) or filter assembly (for films) to make high quality nanotube macrostructures. While the use of hazardous solvents like DMAc, DMF, etc. do not appear to enhance the process, sonication can be used to enhance the macrostructure properties. Increasing the viscous solvent volume percentage in the solvent mix can enhance the dispersion quality. There may be an optimal ratio for the solvent mix, leaning towards higher volume percentage of the viscous fraction. Additionally, for the formation of macrostructures, sonication-induced functionalization on the edges of the nanotubes may also increase the macrostructure strength.

Fibers were prepared from dispersions made by the methods described herein; ˜10 and ˜25 μm diameter fibers were spun from a syringe spinnerette of 60 and 160 μm diameter at a draw ratio <1. The significance of this demonstration is that this solvent mixture does not contain any polymer surfactants and no sonication was used. This essentially eliminates the two largest problems associated with processing nanotubes: contamination of the structures via polymers that are hard to remove and degradation of the nanotubes from sonication.

Additionally, a film was prepared from dispersions made by the methods described herein. The film had a thickness of ˜5 μm and good mechanical strength. The film was folded into an airplane structure, demonstrating both the mechanical robustness and structural potential of methods described herein.

### Example 2—a Surfactant- and Sonication-Free Method for the Dispersion Processing of Boron Nitride Nanotubes into Macrostructures

Abstract. Herein, a method is reported to process boron nitride nanotubes (BNNT) from alcohol dispersions into macrostructures such as fibers and films. BNNTs are dispersed in a solvent that wets the BNNTs (such as C1-C4 alcohols), then a second miscible solvent with higher viscosity (such as glycerol) is added. The first solvent step offers an initial dispersion, but this single solvent dispersion is not easily processable into good macrostructures. These initial dispersions contain high amounts of large entangled bundles that do not pack well. The second dispersion step involves the addition of an additional miscible solvent to increase the solvent mix viscosity and form a favorable mix morphology. The dispersion from the binary solvent mixture shows significantly lower nanotube bundle sizes, allowing for processing into higher performance macrostructures. The second solvent addition allows the processing of these dispersions at two orders of magnitude higher shear stresses, increasing alignment and performance of the resultant macrostructure. Additionally, the methods described herein do not use polymer surfactants or sonication, both of which have an impact on the chemistry or mechanical performance of the final structure. Boron nitride is a known electrical insulator and highly aligned nanotubes can offer thermal conductivity up to 500 W/mK (˜2× the thermal conductivity of aluminum). Additionally, these fibers and films have high temperature applications and are viable in applications where the material processing conditions are conducted at high temperature (e.g. metallurgy). These fibers and films are stable in oxygen up to 900° C. and stable in inert environments up to 2000° C. Further optimization of these processing conditions can further increase mechanical and thermal performance.

Introduction. In the last two decades, innovations have been made in the synthesis and applications of nanotubes, including carbon nanotubes (CNT) and boron nitride nanotubes (BNNTs). BNNTs are electrical insulators with a band gap of 5-6 eV, oxidative resistance up to 900° C. [1], low-k dielectric properties [2], high thermal conductivity [3], and high strength [4]. This combination of properties makes BNNTs ideal for structural applications involving high heat loads and electrically insulative properties. This includes semiconductors, high power electrical cabling, and space structures. Processing of the BNNTs into fibers and films has some dependance on the amount and form of impurities, and the nanotube alignment developed in the processing steps can be imparted to the final BNNT network [5-7]. Both CNTs and BNNTs have been combined with polymers, ceramics, and metals and processed for added functionality of the created film, fiber, or bulk material. For applications in fibers and films, scale of production, BNNT aspect ratio, and BNNT purity are important production parameters. Nanotubes with sufficiently high aspect ratio and purity are needed to maintain enough overlap and contact between adjacent tubes to hold these structures together.

Dispersion processing of BNNTs have relied on sonication and centrifugation to separate the components based on sedimentation tendencies [8-9]. Sonication is needed to disperse the BNNTs before removal of sedimented material, which has also been shown to damage the BNNTs [10]. Although wet thermal etching and centrifugation methods are cited as producing 99-100% purity BNNT samples, commercial availability of these high-purity samples has been limited to 90-95% purity with most commercial production containing <75% BNNT purity until the last 5 years [11]. However, enhancements in purity have not necessarily made BNNTs a commercial success. There are still multiple issues associated with processing BNNTs from dispersions into macrostructures including the use of costly and hazardous solvents and the tradeoff between conventional dispersion methods involving the use of polymer surfactants and sonication to improve dispersibility at the cost of contamination or chemical degradation of the BNNTs in the final macrostructure.

Nanotube films have typically been produced using a vacuum filtration method [12], [13]. This method has been controlled through the use of various filter pore sizes, where small sizes allow more time for the nanotubes to align locally [13], and the use of surfactants and sonication to improve the BNNT dispersion, where less nanotube entanglements provide less barriers to local alignment [12]. While nanotube film production methods have been thoroughly explored, thus far, only two works have effectively employed macro-scale processing methods to produce ordered BNNT fibers. Two methods have to-date been reported for making BNNT fibers: wet spinning of BNNT solution [14] and direct spinning of BNNT plume from the synthesis reactor [15]. The wet spinning involves forming liquid crystalline phase of BNNT in superacid, such as chlorosulfonic acid (CSA), and resulted in BNNT fibers with low alignment, average modulus of 1.5 GPa, and an average tensile strength of 16 MPa [14]. BNNT synthesis using high-enthalpy plasma to manufacture kilogram quantities of high-purity BNNTs, resulted in BNNT yarn or fiber spun from the plasma with a modulus of ˜0.5 GPa and a tensile strength of ˜10 MPa [15]. Wet spinning appears most easily adapted to processing BNNTs because of its flexibility with type of synthesis method and allows for further processing of BNNTs to higher purity. Due to the hazards associated with handling of CSA, there are many equipment- and safety-related issues associated with its commercialization.

Herein, the exemplary method does not require hazardous solvents, sonication, or surfactants to process boron nitride nanotubes (BNNT) from dispersions into macrostructures such as fibers and films. Other work [16-18] and patents [19-21] have been documented in this area. However, this work represents the first demonstration of the utility of high viscosity solvent mixtures and surfactant- and sonication-free processing methods to disperse BNNTs and then to use these dispersions to successfully create BNNT macrostructures of fibers and films with good performance. While the study shows that polymer surfactants are not necessary to form good dispersions of nanotubes, the study shows that these alcohol dispersions can be sonicated to promote chemical functionalization of the nanotubes. Further studies determined the thermal and mechanical properties of the macrostructures and the effects of various processing on the macrostructure properties.

### Experimental

Materials. Boron nitride nanotubes were obtained from BNNT, LLC. Isopropanol, ethanol, and glycerol were used as-received from Sigma Aldrich.

Processing. BNNT dispersions in alcohol/glycerol solvent mixtures were made by first adding a measured weight of nanotubes to the alcohol stirring at a set rpm. This was left to mix for at least 1 hr before adding glycerol slowly while maintaining stirring. The alcohol/glycerol nanotube dispersion was then stirred overnight. For dispersions with 100% glycerol, the more volatile alcohol was evaporated by stirring at 70° C. overnight then removing any remaining alcohol using vacuum at 40 mbar and 70° C. For dispersions of edge-functionalized BNNTs, the dispersion still containing the volatile alcohol species is sonicated for at least 30 minutes prior to any further processing.

Fibers were spun by syringe with both flat, circular syringe tips and flat, oval syringe tips. The dispersions were first centrifuged at set g-levels and times, removing the excess liquid to concentrate the nanotubes in the glycerol component. These highly-concentrated dispersions were then added to a 3 mL syringe and extruded through the syringe tip of choice. Syringe spinning down to 60 μm diameter was successful. The syringe spinning was conducted into a variety of “coagulation” baths including methanol:deionized water (DIW), 100% DIW, acetone, isopropanol (IPA), and 5 weight percent (wt %) polyvinyl alcohol (PVA) in DIW, all of which worked to form fibers that maintained their shape after extrusion and drying.

Films were created by adding the as-made solvent mixture dispersions into a reservoir connected to a filter and vacuum pump, where the liquid is slowly pumped through the filter to leave the nanotubes as a self-supporting film. These films can be made with random orientation by using larger filter sizes that remove solvents faster. A well-known method to impart local alignment is by removing solvent slowly using very small diameter filter sizes (0.2 μm). Here, the method employed the noted dispersion procedure. Then, the dilute mixture is extruded through a syringe onto the filter before starting vacuum in order to impart more local alignment.

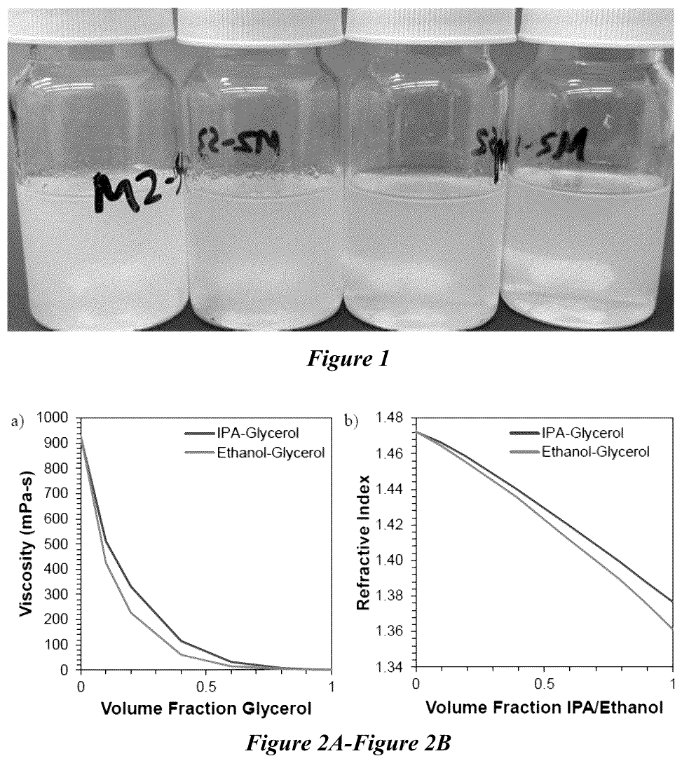

Results. FIG. 1-FIG. 11D show a comparison of the dispersion processing and dispersion quality for state-of-the-art BNNT dispersions in Pluronic F127 surfactant and DIW.

FIG. 1 shows BNNT dispersions with increasing vol % glycerol left to right; the stir bar becomes increasingly visible to indicate there is a change in the BNNT bundle size and scattering of the dispersion.

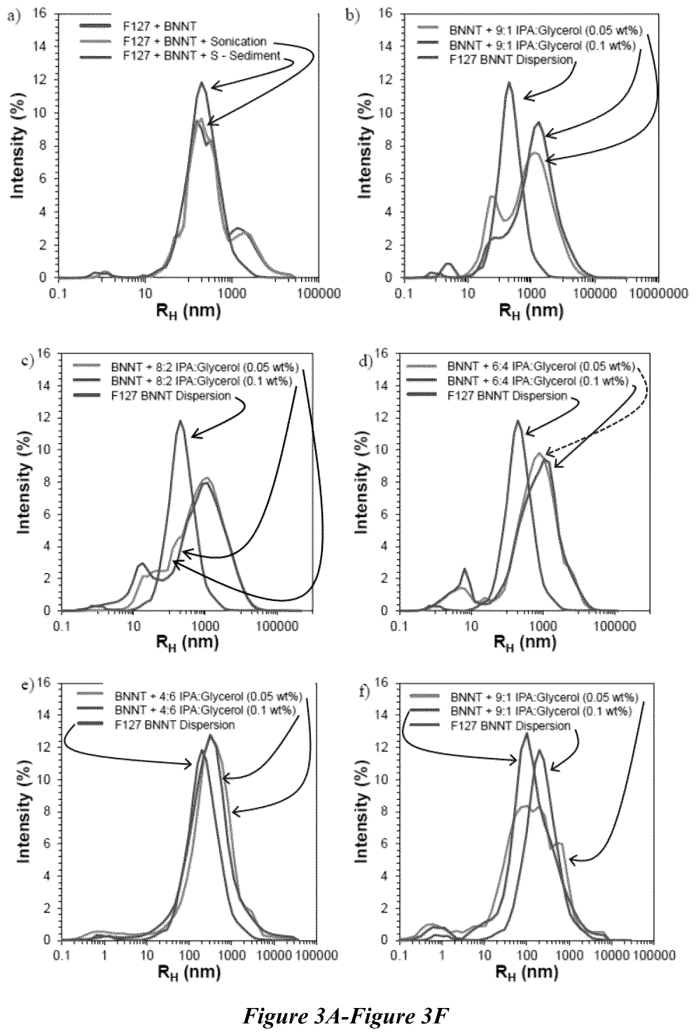

FIG. 3A-FIG. 3F show a comparison of surfactant dispersion using Pluronic F127 to those using varying vol % glycerol. The results showing decreasing bundle size exceeding the performance of the F127 surfactant dispersion at 90 vol % glycerol.

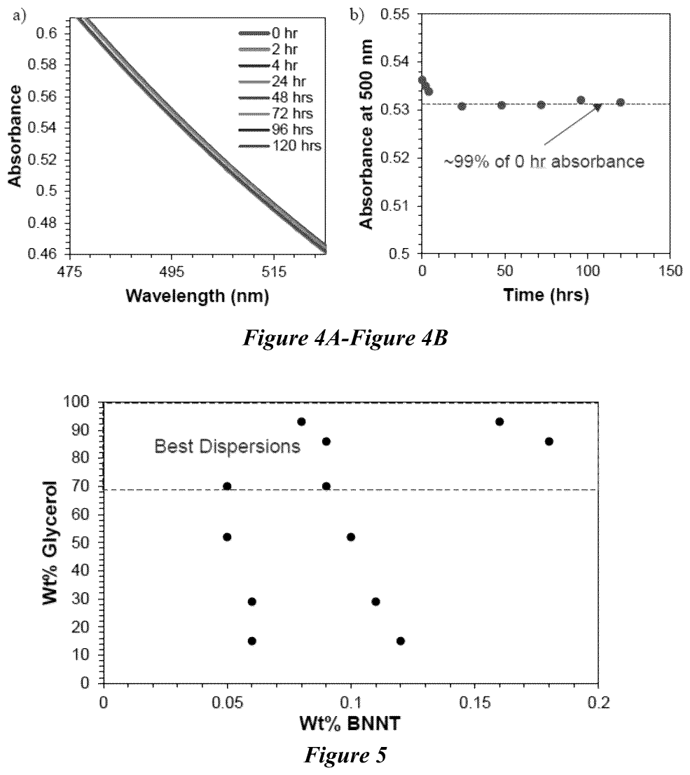

FIG. 4A-FIG. 4B show UV-vis of 60 vol % glycerol dispersion as a function of time, showing the very high dispersion stability of even the 60 vol % glycerol dispersion.

FIG. 5 is a rough phase diagram of BNNT content vs glycerol content in the solvent mixture; the marked region shows the point where the dispersion bundle size is comparable to or lower than the surfactant-assisted dispersions from Pluronic F127.

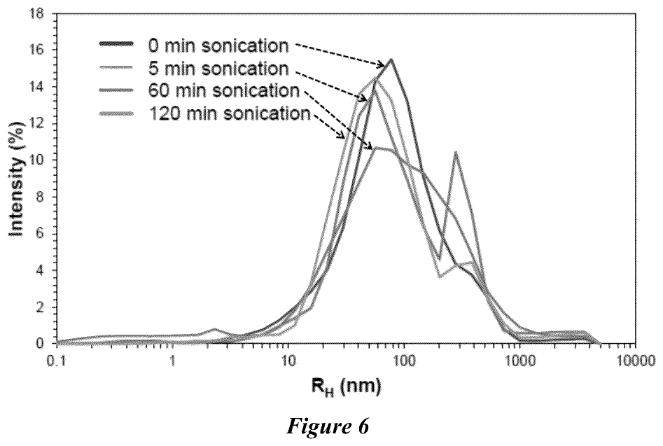

FIG. 6 shows the impact of sonication time on the bundle size distribution of ˜100% glycerol dispersion after solvent exchange from IPA; sonication has minimal impact at high vol % glycerol, but still results in bundle size distribution reduction.

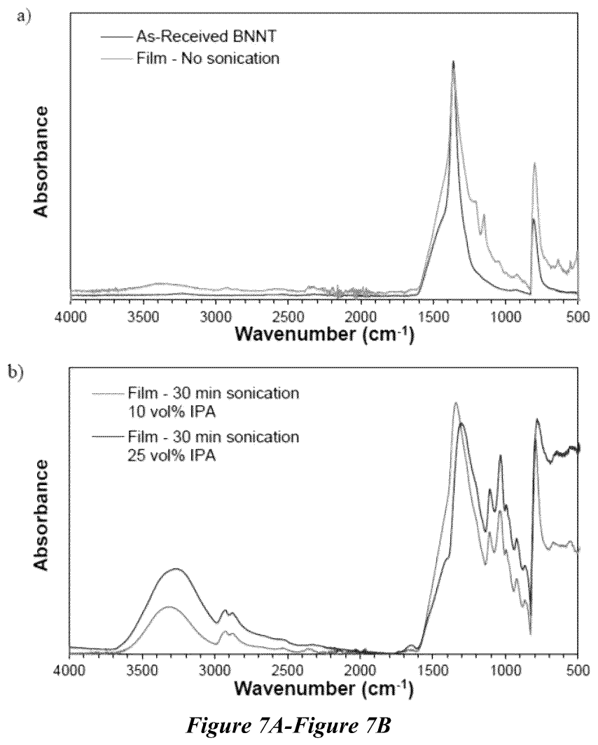

FIG. 7A shows that there is little chemical change after film-making process with no sonication. FIG. 7B shows that chemical functionalization of BNNTs from sonication of dispersions containing IPA—functionalization tends to increase with more IPA content.

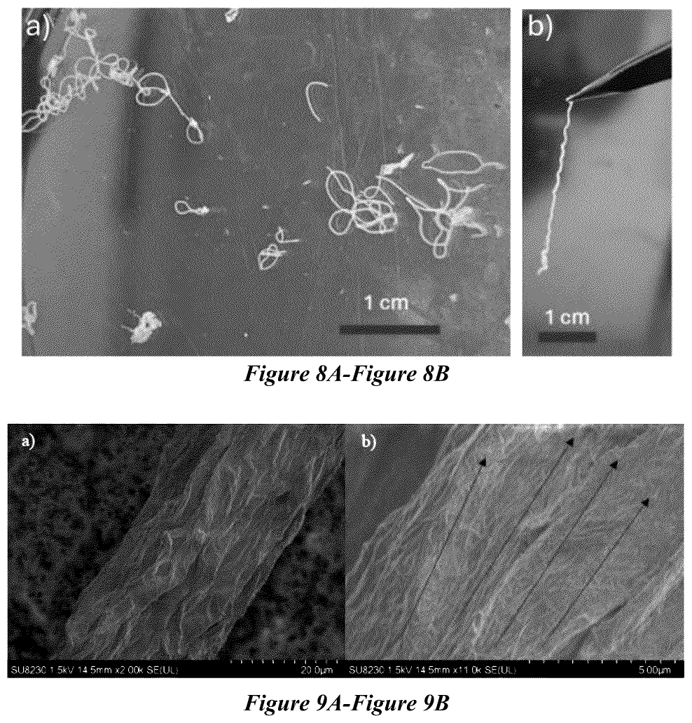

FIG. 8A-FIG. 8B show images of BNNT fibers; fibers maintain their shape and integrity after spinning.

FIG. 9A-FIG. 9B show images of BNNT fibers, showing some visible local orientation imparted by shear forces during spinning.

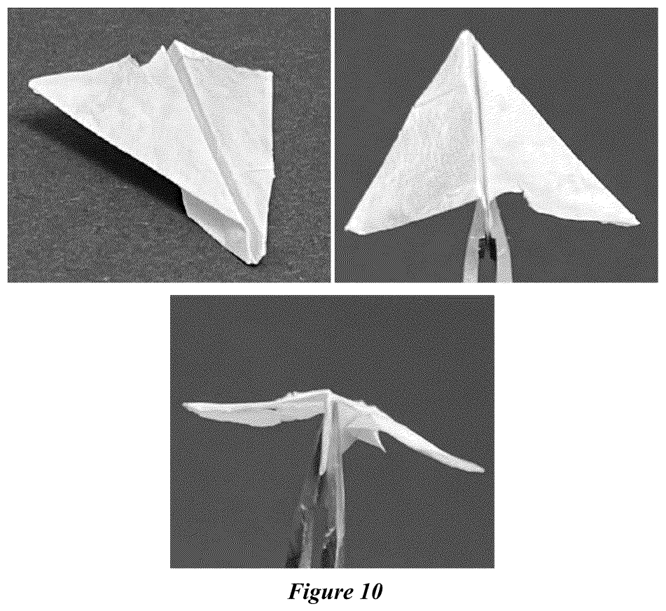

FIG. 10 shows images of folded paper airplane from BNNT buckypaper/film-making process, indicating structural integrity, flexibility, and processability.

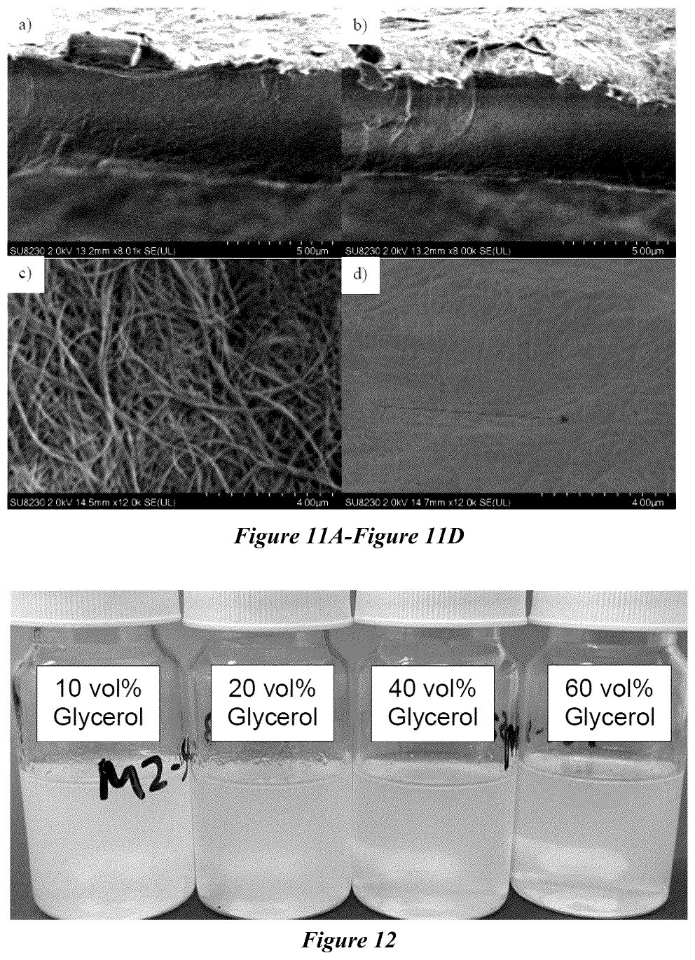

FIG. 11A-FIG. 11D are SEM images of BNNT films showing (FIG. 11A-FIG. 11B) ˜5 μm thickness, (FIG. 11C) random alignment, and (FIG. 11D) local alignment around random nanotube placement.

### REFERENCES

[1] N. Kostoglou et al., Nanomaterials, 2020, 10(12), 2435.
[2] X. Hong et al. J Electron Mater, 2016, 45(1), 453-461
[3] Y. Xiao et al. Phys Rev B, 2004, 69(20), 205415
[4] X. Wei et al. Advanced Materials, 2010, 22(43), 4895-4899
[5] V. R. Kode et al., ACS Appl Nano Mater, 2019, 2(4), 2099-2105
[6] P. Nautiyal et al. Adv Eng Mater, 2016, 18(10), 1747-1754
[7] T. Terao et al. Journal of Physical Chemistry C, 2010, 114(10), 4340-4344
[8] S.-H. Lee et al. Int J Mol Sci, 2020, 21(4), 1529.
[9] H. Harrison et al., Nanoscale Adv, 2019, 1(5), 1693-1701
[10] C. H. Lee et al. The Journal of Physical Chemistry C, 2012, 116(2), 1798-1804
[11] M. B. Jakubinek et al., Advanced Materials. TechConnect Briefs 2017, 1, 114-117
[12] S. Sharma et al. J Mater Sci, 2017, 52(12), 7503-7515
[13] J. S. Walker et al., Small, 2022, 18(11), e2105619
[14] C. J. Simonsen Ginestra et al., Nat Commun, 2022, 13(1), 3136
[15] K. S. Kim et al., ACS Nano, 2014, 8(6), 6211-6220
[16] C. S. Torres Castillo et al. Nanoscale Adv., 2020, 2(6), 2497-2506
[17] D. Kim et al., Chemical Communications, 2015, 51(33), 7104-7107
[18] M. Kang et al., Nanomaterials, 2023, 13(18), 2593.
[19] U.S. Pat. No. 8,349,903B2
[20] US20230307653A1
[21] U.S. Pat. No. 9,636,649B2

### Example 3—A Surfactant- and Sonication-Free Method for the Dispersion Processing of Boron Nitride Nanotubes into Macrostructures for High-Temperature Heat Management

Abstract: Herein, a method is reported to process boron nitride nanotubes (BNNT) into fiber and film macrostructures from alcohol dispersions. BNNTs are initially dispersed in isopropyl alcohol, followed by addition of glycerol to increase the mix viscosity. The single alcohol dispersion contains large, entangled BNNT bundles that are not easily processed into good macrostructures. The addition of glycerol in the second dispersion step significantly lowers the nanotube bundle sizes and permits processing into higher performance macrostructures with two orders of magnitude higher shear stresses. This advancement has been made without the use of polymer surfactants or sonication, both of which can negatively impact the chemical and physical composition of nanotubes in the macrostructure. The BNNT films made from this processing method have thermal conductivities as high as 44 W/mK, dielectric breakdown strengths as high as 160 kV/mm, and dielectric constants in the range of 2.0-7.0 at 1-100 MHz. Additionally, these films are viable in high temperature applications with high thermal shock requirements. High heat flux laser testing showed that the BNNT films can survive short bursts of 80, 60, and 40 W/cm² heating as well as 100 cycles at 20 W/cm² heating and cooling cycles. Factorial 23 experimental design was also used to better understand how much sonication, glycerol content, and BNNT concentration were impacting the film performance. Higher BNNT concentrations in the dispersion are shown to have a significant positive impact on the thermal diffusivity of the films. Additionally, the dielectric breakdown of the films showed a significant positive effect from higher BNNT concentrations and a conflicting interaction between concentration and glycerol content. Finally, the use of sonication was shown to have a significant, negative impact on the dielectric permittivity of the films due to higher carbon content in the films from alcoholysis of the BNNTs. Further optimization of these processing conditions can further increase film performance.

Introduction: Existing literature regarding BNNTs have used a combination of sonication [A1], chemical functionalization [A2], and polymer surfactants [A3] to disperse BNNTs. Unlike non-attractive particles, nanotubes form bundles and entangle at fixed points as a result of their van der Waals attractive forces. To disperse the BNNTs, the solvent polarity, viscosity, and surface interaction with the nanotubes dictate whether the nanotubes remain disentangled. Good dispersions of BNNTs have largely been recorded with solvents such as dimethyl formamide (DMF), dimethyl acetamide (DMAc), dimethyl propylene urea (DMPU) [A4], and chlorosulfonic acid (CSA) [A5], which have their own safety and handling issues that increase costs and danger to personnel. Furthermore, sonication is used to disperse the nanotubes in solvent but often applies too much cavitation force that reduces the length of the nanotubes and impacts the macrostructure performance [A1].

While chemical functionalization disperses nanotubes by incorporation of functional groups on the tube wall that result in a net repulsion between adjacent tubes, polymeric surfactants wrap the nanotube surface in a polymer that separates and repels nearby wrapped tubes. Polymer surfactants have been used to improve dispersion quality, but the presence of polymer causes contamination that is detrimental to many applications. It is difficult to remove all of the polymer, and even <5 wt % of carbon contamination can lower performance of a dielectric material with intended use in heat management.

Alcohols have also been reported to disperse BNNTs well due to their similar polarity and surface energy to the BNNTs [A4, A6]. Additionally, viscous liquids, such as glycerol, have been used to increase shear force and disentangle carbon nanotubes (CNT) simply by stirring at moderate concentration [A7]. Higher viscosity also reduces the rotational diffusion and tendency for these rod-like particles to re-entangle within the dispersion [A8]. This work on binary alcohol dispersions relies on two foundations from higher viscosity dispersion methods-increased shear breaks up nanotube bundles and lower rotational diffusion reduces the tendency for re-entanglement.

The dispersibility of BNNTs have been studied in single solvent systems [A4], dispersant-free systems [A6], and from sonication in alcohols [A9]. However, this work is the first to demonstrate the utility of high viscosity solvent mixtures to disperse BNNTs without added surfactant or sonication. Additionally, statistical analysis of processing effects from this method are studied to determine the impact on the thermal and dielectric performance of BNNT films. Herein, a new method is reported that does not require hazardous solvents, sonication, or polymer surfactants to process boron nitride nanotubes (BNNT) from dispersions into macrostructures such as fibers and films.

### Experimental

Materials: Boron nitride nanotubes were obtained from BNNT, LLC. Isopropanol, ethanol, and glycerol were used as-received from Sigma Aldrich.

Processing: BNNT dispersions in alcohol/glycerol solvent mixtures were made by first adding a measured weight of nanotubes to the alcohol stirring at a set rpm. This was left to mix for at least 1 hr before adding glycerol slowly while maintaining stirring. The alcohol/glycerol nanotube dispersion was then stirred overnight. For dispersions with 100% glycerol, the more volatile alcohol was evaporated by stirring at 70° C. overnight then removing any remaining alcohol using vacuum at 40 mbar and 70° C.

Fibers were spun by syringe with flat tip, circular and oval needles. The dispersions were first centrifuged at high g-levels and times, removing the excess liquid to concentrate the nanotubes in the glycerol component. These highly concentrated dispersions were then added to a 3 mL syringe and extruded. Syringe spinning down to 60 μm diameter was successful. The syringe spinning was conducted into a variety of “coagulation” baths including methanol/deionized water (DIW), 100% DIW, acetone, isopropanol (IPA), and 5 weight percent (wt %) polyvinyl alcohol (PVA) in DIW, all of which worked to form fibers that maintained their shape after extrusion and drying. 3D printing was conducted using a nScrypt 3Dn-300 3D direct printing system with 200 μm diameter syringe nozzle.

Films were created by adding the as-made solvent mixture dispersions into a reservoir connected to a 0.22 μm Teflon filter and vacuum pump, where the dispersion is slowly pulled through the filter to leave the nanotubes as a self-supporting film. Dead-end filtration has at least four processing parameters that can be adjusted and studied. Table 1 lists the controllable processing factors; regions of interest were identified after initial testing and are bolded and italicized.

TABLE 1
BNNT film processing factors and areas of interest.

| | S—Sonication | | G—Glycerol | B—BNNT | | F—Filter | |
|---|---|---|---|---|---|---|---|
| Level | time | | wt % | wt % | | size | |
| Lower (−−) | 0 | mins | 40 wt % | 0.005 | wt % | 0.22 | μm |
| Low (−) | 10 | mins | 60 wt % | 0.1 | wt % | 0.45 | μm |
| Baseline (1) | 30 | mins | 80 wt % | 0.2 | wt % | 1.0 | μm |

| | | | | | | |
|---|---|---|---|---|---|---|
| High (+) | 1 | hr | 90 wt % | 0.3 | wt % | — |
| Higher (++) | 2 | hr | 98 wt % | 0.4 | wt % | — |

Reduction of the filter pore size, and lowering the rate of filtration, is a well-known method to impart local alignment by allowing the nanotubes more time to orient before settling [A10]. With filter size constant at 0.22 μm, the design philosophy of this experimental design is to study the properties of the final BNNT film to determine, statistically, which parameters from the binary alcohol processing method have the most impact on the final BNNT film performance. Table 2 shows the experimental matrix of BNNT film processing factors and values that were tested. Eight samples were made, allowing for efficient determination of the impact of the processing factors and the interactions among factors on the film thermal conductivity, dielectric breakdown, and dielectric constant.

TABLE 2
Factorial experimental design 2³ with filter size constant.

| | S—Sonication | | G—Glycerol | | B—BNNT | |
|---|---|---|---|---|---|---|
| Sample | time | | wt % | | wt % | |
| S0-G80-B0.2 | 0 | mins (−) | 80 | wt % (−) | 0.2 | wt % (−) |
| S1-G80-B0.2 | 1 | hr (+) | 80 | wt % (−) | 0.2 | wt % (−) |
| S0-G98-B0.2 | 0 | mins (−) | 98 | wt % (+) | 0.2 | wt % (−) |
| S1-G98-B0.2 | 1 | hr (+) | 98 | wt % (+) | 0.2 | wt % (−) |
| S0-G80-B0.4 | 0 | mins (−) | 80 | wt % (−) | 0.4 | wt % (+) |
| S1-G80-B0.4 | 1 | hr (+) | 80 | wt % (−) | 0.4 | wt % (+) |
| S0-G98-B0.4 | 0 | mins (−) | 98 | wt % (+) | 0.4 | wt % (+) |
| S1-G98-B0.4 | 1 | hr (+) | 98 | wt % (+) | 0.4 | wt % (+) |

Characterization: Characterization was performed on the BNNT dispersions with varying wt % of alcohol. Accurate viscosity and refractive index values for the neat solvent mixtures are needed for determination of the BNNT hydrodynamic radius from Dynamic Light Scattering (DLS). Refractive index measurements were collected using a Reichert Abbe Mark III Transmission Refractometer with temperature control at 25° C. Viscosity measurements were performed on a MCR302 Anton Paar Rheometer controlled at 25° C. over a 1-100 Hz sweep with a 50 mm diameter, 1° cone and plate setup at 1 mm gap. Dynamic Light Scattering, using a Wyatt DynaPro NanoStar, was conducted on the binary alcohol BNNT dispersions. DLS was conducted at 25° C., 40 acquisitions 10 seconds each, and the correlation function was calculated over a 1.5 s-10 s range.

BNNT films were made by vacuum filtering the BNNT dispersions with a Teflon 0.22 μm pore filter. After vacuuming out the solvent, films were washed with 200 mL of methanol and 200 mL of de-ionized water (DIW). Any remaining solvent was removed by heating the films to 150° C. under vacuum for 2 hours. Density was calculated by weighing the sample and estimating volume from the diameter and thickness measured using a micrometer with 0.25-inch diameter plates.

The morphology and chemical composition of the films were captured using a Hitachi SU8230 SEM equipped with an Oxford energy-dispersive X-ray spectroscopy (EDS) detector. Additional chemical analysis was performed using Fourier Transform Infrared Spectroscopy (FTIR) was performed using a Nicolet 6700 FT-IR with diamond crystal Attenuated Total Reflectance attachment. Thermal and dielectric property characterization was performed at NASA Glenn Research Center. Thermal diffusivity measurements were performed at room temperature using both in-plane and through-plane masks on a NETZSCH Nanoflash 447 Laser Flash Apparatus (LFA). Thermal conductivity was estimated by multiplying the LFA diffusivity by the film density and heat capacity calculated from Differential Scanning Calorimetry (DSC). For heat capacity, a TA Instruments DSC250 was used. The sapphire method was used to calculate heat capacity of the film using the known weight of the film sample and sapphire standard values. Dielectric breakdown was performed in silicone oil using AC voltage applied at 0.6 kV/s using an Eaton High Voltage Test Setup. For thermal conductivity and dielectric breakdown, 0.5-inch circular samples were used. The dielectric constant was studied using an Agilent 4294A Precision Impedance Analyzer using a frequency sweep of the capacitance from 100 Hz to 100 MHz. For dielectric spectroscopy, 0.25-inch diameter circular samples were pressed between copper foil 0.25-inch in diameter.

Results: The development of surfactant and sonication-free methods for BNNT dispersion were based on prior findings by Kobashi et al. and Wang et al. on CNT dispersions and fibers. Viscous liquids, including glycerol and silicone oil, can reduce CNT aggregate size and straighten inhomogeneous bundles into long and thin strands by increasing shear on the nanotube aggregates [A7]. Glycerol was chosen instead of other viscous solvents, such as silicone oil, due to its miscibility with other common solvents with comparable polarity to the BNNTs. Similar dipole moments between the solvent mix and BNNTs allow sufficient force transfer from the solvent molecules to the nanotubes, and the high viscosity prevents slippage of the nanotube connections once aligned. To facilitate slippage of the CNT connection points, work by Wang et al. heated glycerol to 120° C. to lower the viscosity and align the CNTs in a fiber structure [A11]. The polarity-driven shear transfer behavior of glycerol and the viscosity-driven softening of nanotube connections form the basis of this work. Instead of increasing the glycerol temperature to reduce viscosity, adding a second solvent with similar polarity, such as an alcohol, to glycerol was used to lower the viscosity and enable slippage of the nanotube connections. A hypothesis is that the slow addition of glycerol to low-viscosity alcohols will soften the nanotube connections and disentangle the BNNT bundles. Additionally, when the major component of the final dispersion is glycerol, the high viscosity of the dispersion prevents the BNNT bundles from re-entangling.

The aforementioned shear transfer and connection-softening properties allow for the dispersions of BNNTs in IPA/glycerol to form films and fibers. In a typical process, BNNTs were added to isopropyl alcohol (IPA), mechanically stirred to break up agglomerates, then glycerol was added slowly while stirring (1400 rpm). To optimize the process, the quantities of IPA and glycerol were varied, in addition to BNNT wt % and the use of sonication. Higher vol % of glycerol leads to more translucent solutions and better BNNT dispersions (FIG. 12). Several alcohols were tested as second solvents to glycerol, including ethanol, IPA, and butanol. While the general methodology of mixing glycerol with these alcohols worked with all tested, IPA/glycerol mixtures were chosen to simplify further study.

DLS was used to quantify the BNNT bundle breakdown in higher glycerol content dispersions. Determination of the index of refraction and viscosity of the solvent mixtures (FIG. 23A-FIG. 23B) were measured to ensure accurate estimation of the radius of hydration (RH) of the bundles from DLS experiments. While the dispersions studied were remarkably uniform after stirring, the RH changes from DLS are interpreted as changes in the BNNT bundle size and not to quantify individual nanotube characteristics [A12]. A reduction in the radius of hydration represents smaller bundles of BNNTs and more effective disentanglement.

Pluronic F127 is a known polymer dispersant of BNNTs in DIW [A3], so F127 is used here as a benchmark to evaluate the dispersion quality of the IPA/glycerol dispersions. FIG. 13A shows the bundle size distribution of BNNTs wrapped by Pluronic F127. The dispersion procedure that is standard for F127 uses sonication (F127 BNNT Sonicated) followed by centrifuge and preservation of the supernatant (F127 BNNT Supernatant) that contains F127 wrapped and well-dispersed BNNTs. The supernatant from this standard dispersant procedure is then compared to the BNNT bundle size distribution in IPA/glycerol with increasing glycerol content (FIG. 13B to FIG. 13F).

Unlike the Pluronic dispersions, no centrifugation is conducted on the IPA/glycerol dispersions to separate poorly dispersed BNNTs. The entire BNNT solid content is well-dispersed when increasing the glycerol content and no valuable BNNTs are wasted. While the Pluronic F127-BNNT dispersion maintains a bundle size R_{H} of ˜200 nm, the main species peak of the BNNT dispersions range from a R_{H} of ˜1750 nm with only 10 vol % glycerol (FIG. 13B) to a R_{H} of ˜100 nm with 90 vol % glycerol (FIG. 13F), exceeding the performance of the Pluronic dispersions. A large decrease in the R_{H} of the BNNT bundles occurs once glycerol becomes the higher volume fraction component. At 40 vol % glycerol, BNNT bundle R_{H} is centered on ˜1100 nm (similar performance to 20 vol % glycerol). However, at 60 vol % glycerol there is a significant decrease in R_{H} down to ˜300 nm. Additionally, there does not appear to be a significant dependence of the R_{H} on BNNT concentration below 0.1 wt %. At these concentrations, the dispersion is still relatively dilute, and bundles are mainly interacting with solvent, minimizing the impact of an increase in concentration. To measure the BNNT concentration dependence in the film property studies later in this work, the dispersion concentrations were raised to 0.2-0.4 wt % to better differentiate concentration effects. At these concentrations, BNNTs should have significant tube-tube interactions.

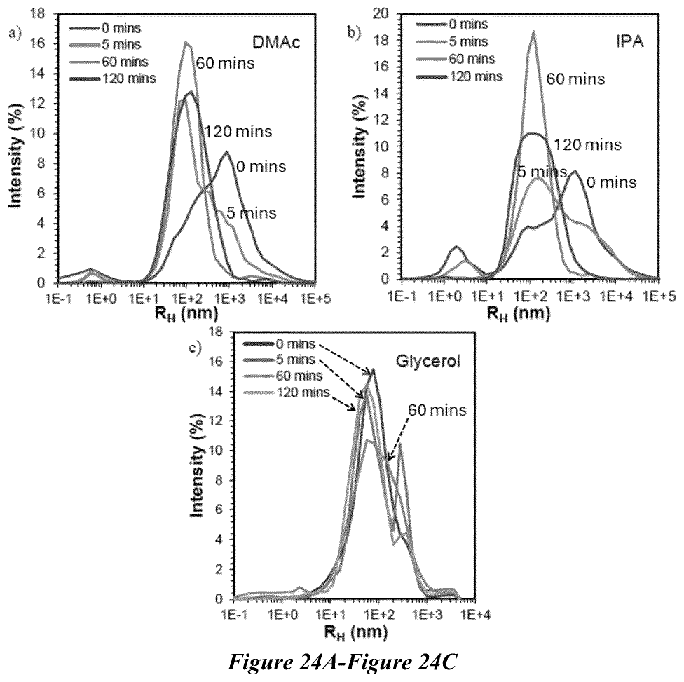

The higher viscosity of glycerol also reduces the effect of sonication. FIG. 24A-FIG. 24C shows the DLS of common solvent systems DMAc (FIG. 24A) and IPA (FIG. 24B) after sonication compared to glycerol (FIG. 24C). IPA and DMAc require 30 minutes of sonication or more to break up bundles and bring the R_{H} in-line with other well-dispersed systems. Glycerol at 0 minutes does not require any sonication to reach the same performance.

Nanotube films have typically been produced using a vacuum filtration method, which controls the film density through the use of various filter pore sizes and vacuum control. Small pores allow more time for the nanotubes to align locally above the filter [A13], and the use of surfactants and sonication is used to reduce entanglements in the BNNT dispersion and provide less barriers to local alignment [A14]. While nanotube film production methods have been thoroughly explored, thus far, only two works have effectively employed macro-scale processing methods to produce ordered BNNT fibers: wet spinning of fibers from a solution of BNNTs in CSA [A15] and direct formation of fibers from the BNNT plume after synthesis [A16]. Both methods led to low performance BNNT fibers with properties around 10 MPa strength and 1 GPa modulus. Wet spinning is most easily adapted to processing BNNTs because of its flexibility with respect to the type of synthesis method and allows for further processing of BNNTs to higher purity. However, due to the hazards associated with handling of CSA, there are many equipment- and safety-related issues associated with its commercialization.

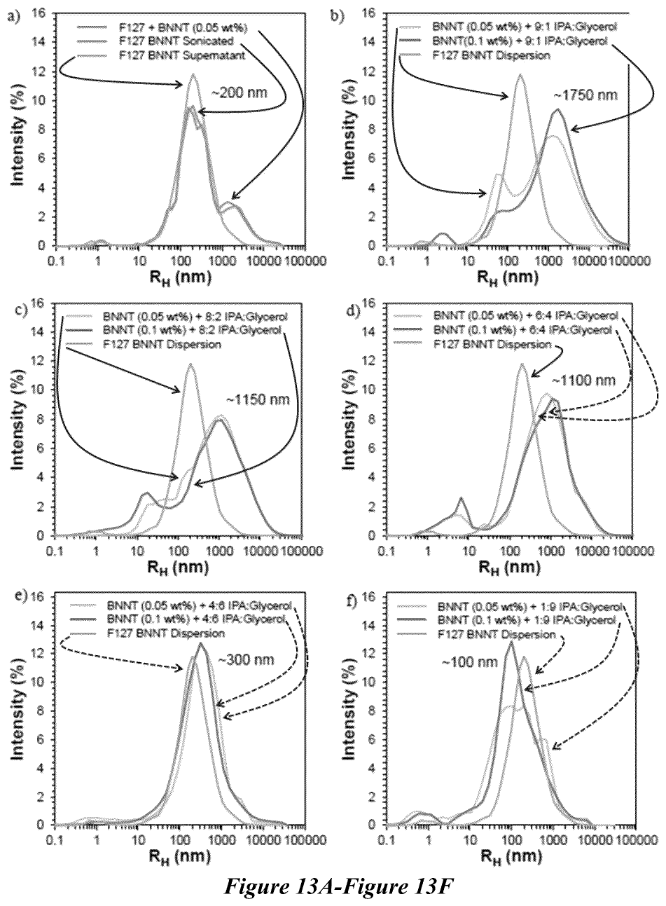

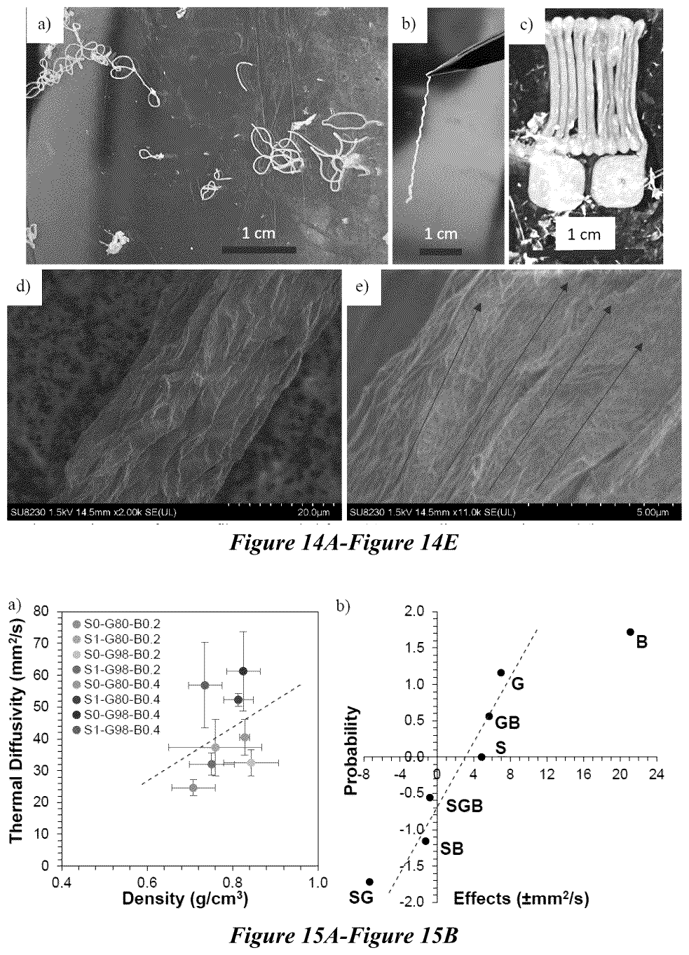

To spin fibers, a 0.1 wt % BNNT dispersion with 60 vol % glycerol was centrifuged to remove excess solvent and concentrate the BNNTs in the glycerol component. Fibers were formed by extrusion into a bath containing quick-drying solvents that are miscible with glycerol (acetone, methanol, and ethanol). These solvents replace the glycerol in the fiber and set the BNNT connections, forming self-supporting fibers after drying (FIG. 14A and FIG. 14B). During spinning, BNNT connections are loosened by glycerol and move past one another to form moderately aligned fibers (FIG. 14D and FIG. 14E). Self-supporting fiber formation did not occur without centrifugation of the initial dispersion, suggesting an increase in viscosity is needed for fiber jetting and maintaining structural integrity after glycerol removal in the bath.

These dispersions can also be 3D printed onto a substrate using a straightforward computer-assisted syringe extrusion process and pattern file. Structures, like the wiring pattern shown in FIG. 14C, are printed to display the complex shapes and patterns with good resolution that can be made from controlled extrusion of the BNNT-glycerol dispersions. The shear transfer and connection-softening properties of glycerol allows these dispersions to be extruded like polymer fibers without entangling and clogging. Similar printing tests on centrifuged dispersions of single solvent systems of IPA, DMAc, and DIW immediately clogged in small diameter syringes and were not extrudable. The capability of spinning these fibers without chlorosulfonic acid, other polymer surfactants, or even sonication represents a significant advancement in the dispersion-processing of BNNTs.

To study the thermal and dielectric properties of the BNNT macrostructures, films were made using a traditional dead-end filtration procedure. Films were washed with methanol and deionized water, then dried in a vacuum oven before testing. These self-supporting films can be produced with thicknesses as low as ˜5 μm, as shown in FIG. 11A and FIG. 11B. The films produced have mostly random alignment (FIG. 11C) with some minor local alignment present (FIG. 11D). Additionally, post-filtration processing, such as stretching or compression/pressing, was not used in this work, but it is expected that performing these steps up to the breaking point of the film will yield better properties due to increased BNNT alignment and densification.

Higher concentration dispersions in the 0.2-0.4 wt % range were studied systematically in film formation, as self-alignment behavior is possible above a critical concentration of nanotubes [A10]. The surface current that acts transverse to the nanotube flow direction over the filter [A13] acts with a shear force that is a function of viscosity and flow rate. It follows that densification of BNNTs can be facilitated via slow filtration with high viscosity solvents. FIG. 10 shows a folded film created from the binary alcohol dispersion and filtration method. After drying, these films possess good mechanical integrity, shown by the ability to fold them into a paper airplane shape.

Film thermal performance: Thermal diffusivity, measured by Laser Flash Apparatus (LFA), was studied to understand the rate of heat transfer inside the BNNT film. High thermal diffusivity can minimize the development of thermal gradients, which is important to the development of dielectric materials that can survive repeated thermal loads in a device without mechanical failure. For the BNNT films measured here, thermal diffusivity has an expected positive relationship with density. BNNTs primarily transfer heat along the nanotube axis, so better packing of BNNTs leads to better 2D thermal management capabilities due to volume reduction of insulating air.

The BNNT films produced have test statistics with densities of 0.78±0.3 g/cm³ and diffusivity of 42±14 mm²/s. The highest diffusivity observed is 62 mm²/s for film S0-G98-B0.4 with 98 wt % glycerol content, 0.4 wt % BNNT content, and no sonication. Multiple measurements were performed on each film to ensure consistent statistics from the anisotropic model used to calculate diffusivity. The relationship of diffusivity with density is not particularly strong (FIG. 15A), so it is expected that the processing effects contribute to a complex material response for thermal diffusivity. To better understand the processing effects, a probability plot and tests for significance were conducted using the 23 factorial design. Non-significant effects lie on a line around zero. Effects are calculated using the +/−matrix in Table 2 and the film property recorded. Single processing factor effects as well as the interaction effects among multiple factors are plotted against the normal probability quantile after ordering the effects based on sign and magnitude (FIG. 15B).

The effect of BNNT wt % (Effect B) is apparent with a positive effect value of +21 mm²/s from increasing BNNT content in dispersion from 0.2 to 0.4 wt %. These results showed that the BNNT weight percent concentration in dispersion clearly has the most significant, positive impact (p=0.0001) on the thermal diffusivity. BNNT weight percent in dispersion has been previously reported to positively impact the packing and alignment of nanotubes within the film [A10]. Additionally, the following effects are not statistically significant but help illuminate some additional processing considerations. Raising the glycerol content by 18 wt % (Effect G) to 98 wt % led to a positive effect value of +7 mm²/s and the interaction effect of lower/higher glycerol content with matching lower/higher sonication (Interaction SG) showed a negative effect value of −7 mm²/s. Lower glycerol content has worse bundle breakdown, and the alcoholysis that occurs during sonication creates a gel-like dispersion that reduces rotational diffusion. When combined, the interaction of effects from lower glycerol content and sonication creates films with worse dispersion qualities and less alignment potential during filtration.

The thermal conductivities of the BNNT samples were calculated from the diffusivity values obtained via LFA. Differential scanning calorimetry (DSC) conducted on the BNNTs showed a specific heat capacity of 0.87 J/g/K, which is in-line with predicted values [A17]. This specific heat value is used with the measured density and diffusivity to calculate the thermal conductivity. Table 3 shows the film properties for the measured samples. For the BNNT films studied here, calculated thermal conductivity averages range from 15 to 44 W/mK. In 2024, Yue et al. showed a room temperature thermal conductivity of 13.4 W/mK for low density BNNT films (0.3 g/cm³) while high density (1.13 g/cm³), aligned films displayed 45.5 W/mK conductivity after mechanical pressing [A18]. The results herein show that the thermal conductivity reaches 44 W/mK at a density of 0.83 g/cm³ from dead-end filtration and drying alone. The BNNTs used in this work have diameters of 3-5 nm while Yue et al. created films from 12-15 nm diameter BNNTs grown using aligned CNTs as templates. The thermal conductivity of the films herein is similar to highly dense and aligned films, likely because of the characteristics of the individual nanotubes used. Work by Chang et al. in 2006 showed that experimental measurements on individual CNTs and BNNTs have a linear dependence between thermal conductivity and nanotube diameter. Individual BNNTs with larger diameter show thermal conductivities below 500 W/mK, but nanotubes with diameter <10 nm are projected to exceed 1000 W/mK [A20]. While the films produced from binary alcohol dispersions have minimal global alignment, they have impressive densities and thermal conductivities for films that have not been mechanically pressed or annealed. The theoretical true density of BNNTs is reported to be approximately 1.38 g/cm³ [A19], so these BNNT films are around 50-60% of the possible density without any post-processing such as stretching or mechanical pressing.

TABLE 3
Film properties from LFA, density estimate,
and calculated thermal conductivity

| | | | Thermal |
|---|---|---|---|
| | Diffusivity | Density | Conductivity |
| Sample | (mm² /s) | (g/cm³ ) | (W/mK) |
| S0-G80-B0.2 | 24.6 ± 2.4 | 0.71 ± 0.05 | 15.1 ± 1.5 |
| S1-G80-B0.2 | 37.3 ± 8.9 | 0.76 ± 0.11 | 24.7 ± 5.9 |
| S0-G98-B0.2 | 32.5 ± 4.0 | 0.84 ± 0.07 | 23.8 ± 3.0 |
| S1-G98-B0.2 | 32.0 ± 3.4 | 0.75 ± 0.05 | 20.9 ± 2.3 |
| S0-G80-B0.4 | 40.5 ± 5.7 | 0.83 ± 0.01 | 29.2 ± 4.1 |
| S1-G80-B0.4 | 52.2 ± 2.0 | 0.81 ± 0.03 | 37.0 ± 1.4 |
| S0-G98-B0.4 | 61.3 ± 12.5 | 0.83 ± 0.04 | 44.0 ± 8.9 |
| S1-G98-B0.4 | 56.8 ± 13.4 | 0.74 ± 0.04 | 36.4 ± 8.6 |

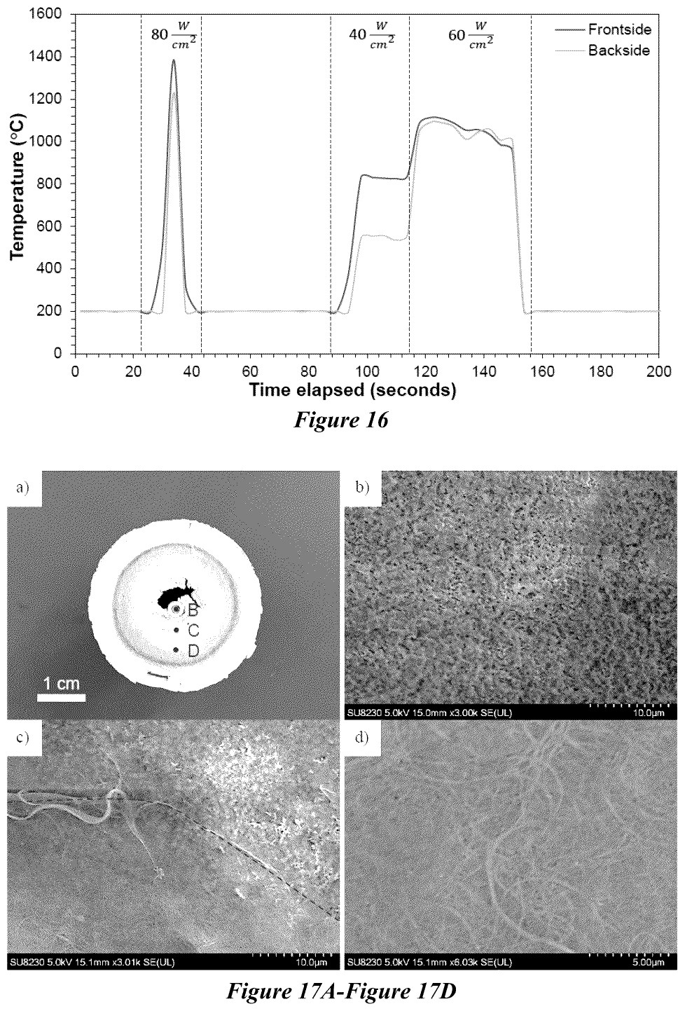

Thermal analysis via high heat flux laser (HHFL) was also conducted. HHFL samples were made by replicating the processing methodology for sample S0-G98-B0.4, which used high glycerol and BNNT content dispersions without sonication to produce the highest thermal conductivity of 44 W/mK. As a torture test, the BNNT film was subjected to 80 W/cm² for 5 seconds. This was followed by a ramping heat flux test that failed after ˜20 seconds at 40 W/cm² and ˜10 seconds at 60 W/cm². The backside temperature difference was recorded to be 154° C. at 80 W/cm², 280° C. at 40 W/cm², and is reduced to 20° C. after failure at 60 W/cm². The heat flux test procedure, including the recorded frontside and backside temperatures, is shown in FIG. 16. Films of hexagonal boron nitride (h-BN) have bulk through-plane thermal conductivity of ˜0.2 W/mK, but this property is highly dependent on the hBN layer thickness as films below 50 nm exhibit through-plane thermal conductivity of ˜1.5 W/mK [A21]. Using a 1D heat transfer model and the film dimensions of 70 μm, the through-plane thermal conductivity is estimated to be 0.2-0.4 W/mK. Through-plane LFA testing determined that the thermal conductivity is in the range of ˜1 W/mK. While the in-plane thermal conductivity of the BNNT film is relatively high, the through-plane conductivity is low. The anisotropy of the BNNT films represents a significant advantage for applications as a thermal protection and management material. This property would allow BNNT films and fibers to move heat primarily away from critical equipment with minimal transfer into the part. Note that the minimum temperature reading on the pyrometer is 200° C. and temperatures reported as 200° C. are likely closer to room temperature.

The HHFL BNNT film sample fails primarily as a result of oxidation to boron oxide. The film reaches temperatures in excess of 1400° C., which is significantly higher than the oxidation temperature of BN (˜700° C.) and the melting temperature of boron oxide (˜450° C.). FIG. 17A shows the failed film and the three regions studied using EDS. FIG. 17B shows the center region with no obvious nanotubes present and with grains that appear like melted droplets due to oxidation and melting of boron oxide. Next to this region is a transition zone where both nanotube regions and oxidized regions are visible (FIG. 17C), followed by a minimally oxidized zone containing mostly nanotubes (FIG. 17D). Table 4 shows the elemental breakdown of the film as a function of the scan distance from the film center. The center (Region B) shows almost complete oxide conversion to B₂O₅. The intermediate region (Region C) is a mixture of BN and B₂O₃, and the outer region (Region D) is primarily BN with a small amount of oxide present. Despite exposure of the entire 1-inch diameter region to the laser heat flux, only a 0.5 cm radius from the center of the film showed significant oxidation. BNNTs near the edge maintain contact with the metal sample holder and are able to transfer heat away fast enough to not oxidize and fail. Although this test was performed in an oxidizing air atmosphere, the film was able to withstand a very high heat flux of 80 W/cm² for 10 seconds without failing as well as 40 and 60 W/cm² for 20-30 second periods.

TABLE 4
Oxidation of the BNNT film as a function
of distance from the center.

| Distance from film | Boron | Carbon | Nitrogen | Oxygen | Empirical |
|---|---|---|---|---|---|
| center (cm) | (wt %) | (wt %) | (wt %) | (wt %) | Formula |
| 0.0 | 21.8 | 0.2 | 3.9 | 74.1 | B₂O₅ |
| 0.5 | 30.0 | 0.5 | 14.2 | 55.4 | B₃N₁O₃ |
| 1.0 | 37.4 | 1.1 | 47.5 | 14.0 | B₁N₁O_{0.3} |

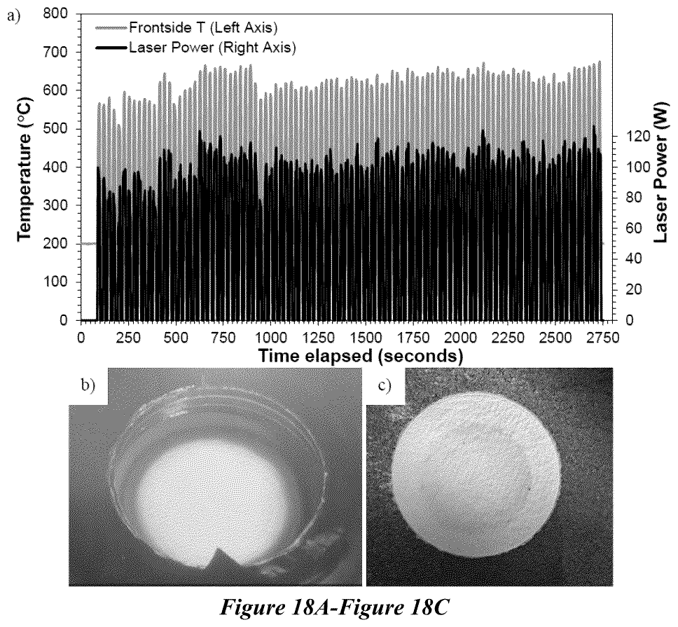

A cyclical heat flux test was also conducted to determine the suitability of BNNT films for applications as heat management materials in devices. A heat flux of 20 W/cm² was applied in a cycle of 10 seconds on followed by 10 seconds off for 100 cycles (FIG. 18A). No obvious thermal runaway was observed, and the film would heat up and cool down within the 10 second heating and cooling cycle. The film survived this cyclical test without issue and maintained its flexibility. FIG. 18B shows the film glowing red-hot after reaching temperatures above 500° C., and FIG. 18C shows the film after 100 thermal cycles. The successful completion of this test is significant, as it shows that the BNNT films can withstand repeat exposure to significant heat flux and cycling by remaining below the ˜700° C. temperature needed for oxidation.

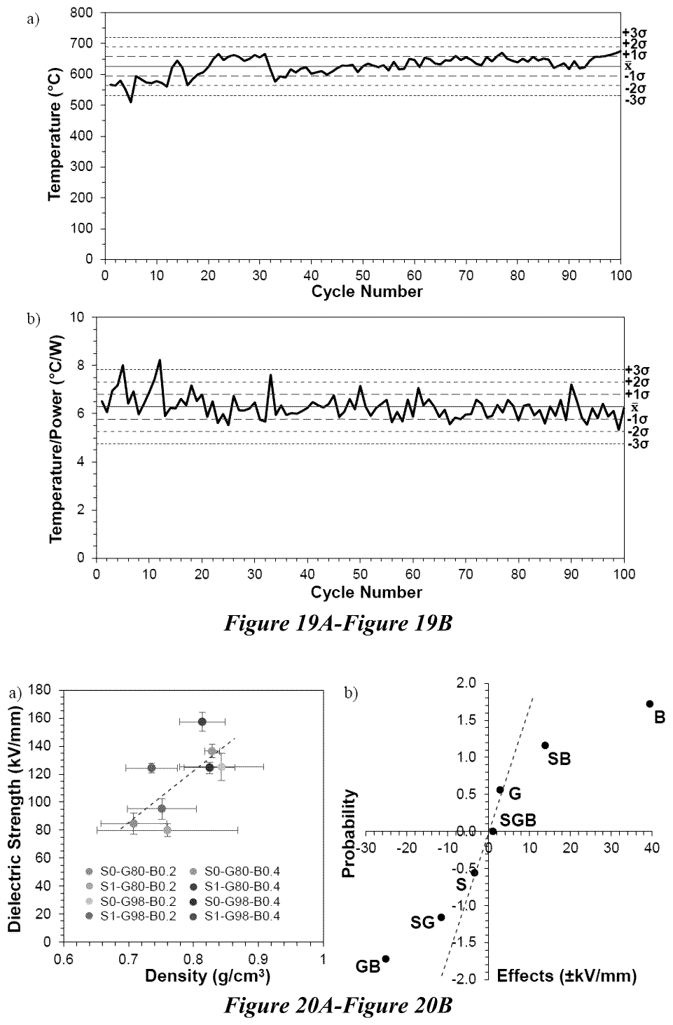

Looking at the progression of temperature over the 100 cycles, control charts of the max temperature vs cycle number (FIG. 19A) and temperature normalized against the laser power (FIG. 19B) were constructed to map the ability of the film to handle thermal cycling over time. While the test begins with the max temperature reached during each cycle lying −1σ to −2σ below the average, the temperature appears to increase above one standard deviation above the mean periodically after 20 cycles. However, this variation is partially due to fluctuation in the laser power at any particular time. FIG. 19B, where the max temperature in each cycle is normalized against the laser power, shows that most of the cycles remain within ±1σ of the average, with some periodic spikes in the cycle temperature above +1σ to +2σ above the average. Higher +2-3σ normalized temperature spikes occurred initially during the test with only a few cycles traveling lower than −1σ. Additionally, FIG. 19B also seems to show a general downward trend in the cycle temperature from 40-100 cycles. Higher number cycles showed less frequent normalized temperature spikes above +1σ and more frequent behavior below −1σ. This could indicate that once the film experiences thermal expansion and contraction from the heat flux, there is some internal rearrangement in the film that facilitates better heat transfer over time.

Film dielectric properties: Dielectric breakdown in solids is a known and well-investigated phenomenon, and the dielectric breakdown of boron nitride can reach a maximum value of 1200 kV/mm [A22]. Breakdown of h-BN and other 2D layered materials is known to occur layer-by-layer [A23]. During breakdown, an avalanche mechanism results from the electrical field giving carriers greater energy than the material band gap to excite electron-hole pairs and results in bond breaking. Breakdown drills a hole through the thickness of the material as bonds are broken. The film dielectric strength was expected to increase with density and increased BNNT contacts, which was observed as shown in FIG. 20A. However, similar to thermal conductivity, the effect of processing on the dielectric performance has many complex causes.

To better understand the processing effects on the dielectric performance, probability charts and tests for significance were conducted using the 23 factorial design. The BNNT films produced have test statistics with dielectric breakdown of 116±30 kV/mm. The highest breakdown observed is 160 kV/mm for film S1-G80-B0.4 with 1 hr sonication, low glycerol, and high BNNT content. Five breakdown measurements were performed on separate samples of each film to ensure statistical significance. Similar to the processing effects on thermal conductivity, these results (FIG. 20B) showed that the BNNT wt % in dispersion (Effect B) has the most significant, positive contribution to increasing the dielectric breakdown (p=0.0007). The effect of BNNT wt % has a positive effect value of +39 kV/mm from increasing BNNT content in dispersion from 0.2 to 0.4 wt %. Additionally, Interaction GB—from glycerol content and BNNT concentration in dispersion—had significant negative effect (p=0.0309). Since Interaction GB is statistically significant, Effect B alone was no longer individually interpreted.

The dielectric breakdown was −34 kV/mm lower than the test average for films processed with lower glycerol content and lower BNNT content (S0-G80-B0.2 and S1-G80-B0.2). Furthermore, alternating processing with higher/lower glycerol content and lower/higher BNNT content produced films with some of the highest dielectric breakdown values. This combination led to a negative effect value of −25 kV/mm for Interaction GB. The alignment mechanism for dead-end filtration is commonly agreed to occur near the membrane surface as a result of a balance of flow-field effects [A24-A26]. The model proposed by He et al. emulates “plate tectonics”. When nanotubes meet above the filter, they rotate to align with each other and merge form larger bundles [A26]. While higher BNNT content creates more immediate nanotube-nanotube contact during rotation, the increased viscosity from added glycerol reduces the extent of rotational diffusion. Dispersions made at higher BNNT concentrations may need to lower the glycerol content to optimize the viscosity for better rotational diffusion and alignment.

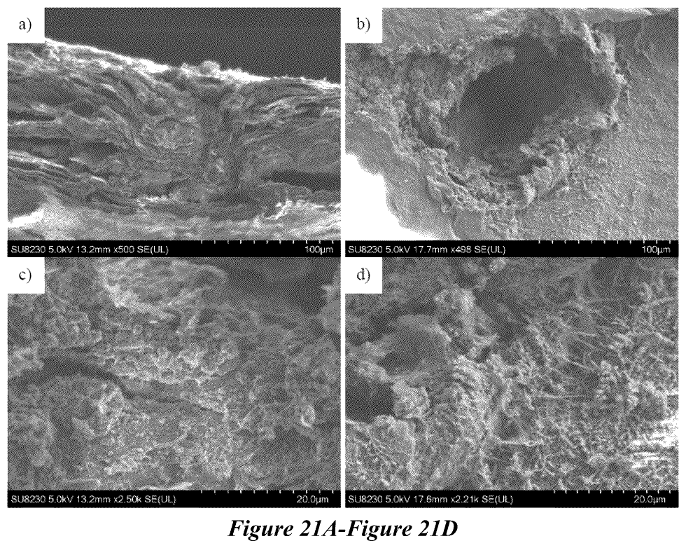

The conducting cavities of the film were imaged after breakdown to better understand the material behavior. Cross-sections (FIG. 21A) of the breakdown pit (FIG. 21B) show a delaminated layer structure following breakdown. This suggests that conduction of current is followed by an expansion of the film and that layers of BNNTs within the film are separating similar to the layer-by-layer breakdown behavior of h-BN. Additionally, melted and oxidized nodules are seen around the cavity (FIG. 21C), demonstrating that the material reached temperatures in excess of 800° C. from Joule heating upon conducting current. While parts of the film clearly melted, nanotubes are still seen to be bridging cracks and defects within the site (FIG. 21D). Fundamentally, whether the film fails at local sites due to mechanical effects or oxidation and melting, BNNTs will still maintain structure at other sites. This makes the BNNT films very robust, as local failures do not necessarily compromise the total film integrity. From this perspective, the BNNT films are unique because they possess the thermal and dielectric properties of BN ceramics with the mechanical behavior and plasticity of polymeric films.

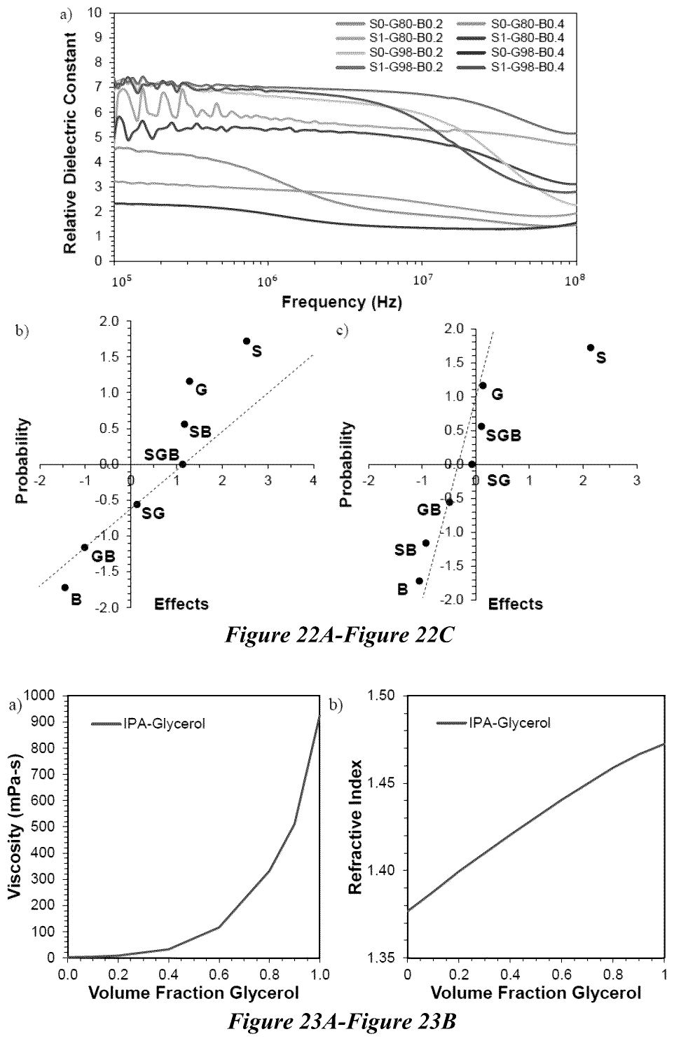

The dielectric constant was measured using dielectric spectroscopy. FIG. 22A shows the dielectric constant calculated from the impedance spectroscopy outputs of capacitance and the sample dimensions. The observed film dielectric constants are within the normal range for BN. The film dielectric permittivity was expected to increase with density, as air that has a dielectric constant of 1 is replaced with BNNTs with a 2.0-7.0 dielectric constant. To better understand the processing effects on the dielectric performance, probability charts and tests for significance were conducted using the 23 factorial design. FIG. 22B and FIG. 22C show the probability charts taken at 1 MHz and 100 MHz. Samples that have been sonicated have higher dielectric constants and experience a higher frequency permittivity drop. Sonication clearly has a significant effect on raising the dielectric constant (p=0.0104). Additionally, sonication for 1 hour (Effect S) leads to a positive effect value of +2.1 added to the dielectric constant. This is because sonication of the BNNTs in alcohols attaches carbon-containing functional groups to the BNNTs at defect sites and edges [A9]. This raised carbon content results in a similar increase in the dielectric constant due to the high permittivity of carbon.

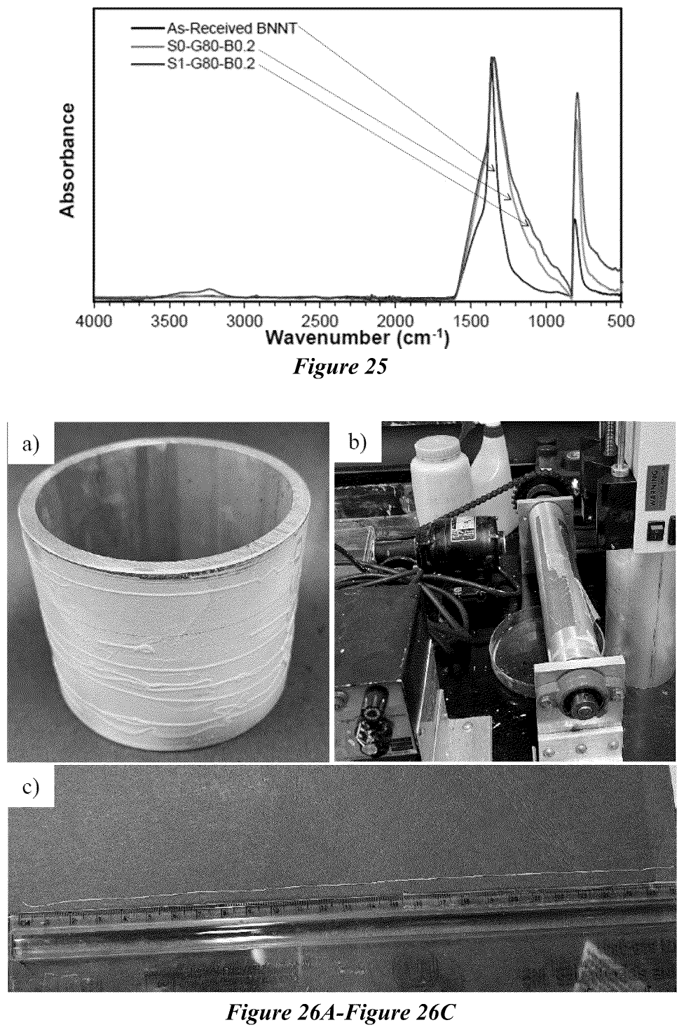

Sonication-induced alcoholysis occurs on the BNNTs with any amount of IPA in the dispersion. To demonstrate the difference in the FTIR signal, FIG. 25 shows samples S0-G80-B0.2 and S1-G80-B0.2 as compared to the as-received BNNTs. The non-sonicated sample 50-G80-B0.2 follows the as-received spectra more closely and has less height in the 1000-1400 and 500-700 cm⁻¹ ranges, where carbon contamination would appear. These results were also confirmed by EDS of the films, showing that the sonicated samples contain ˜5 wt % higher carbon content.

Conclusion: A new method is reported herein to process boron nitride nanotubes (BNNT) into fiber and film macrostructures from alcohol dispersions. BNNTs are initially dispersed in isopropanol, followed by addition of glycerol to increase the mix viscosity. The dispersion in isopropanol alone contains large, entangled BNNT bundles that are not easily processed into good macrostructures. The addition of glycerol in the second dispersion step significantly lowers the nanotube bundle sizes and permits processing into higher performance macrostructures. The addition of glycerol allows for these dispersions to also be extruded from small-diameter spinnerets and syringes without entangling and clogging, similar to polymer fibers. BNNTs, lubricated by glycerol in the dispersion, move past one another and form moderately aligned fibers without the use of chlorosulfonic acid, polymer surfactants, or sonication.

The BNNT films made from this processing method have thermal conductivity as high as 44 W/mK, dielectric breakdown strength as high as 160 kV/mm, and dielectric constant in the range of 2.0-7.0 at 1-100 MHz. High heat flux laser testing showed that the BNNT films can survive short bursts of 80, 60, and 40 W/cm² heating as well as 100 cycles at 20 W/cm² heating and cooling cycles. The processed films are stable in oxygen up to 900° C. Factorial 23 experimental design was used to better understand how sonication, glycerol content, and BNNT concentration were impacting the material performance. Higher BNNT concentrations in the dispersion are shown to have a significant positive impact on the thermal diffusivity and dielectric breakdown of the films. Also, sonication was shown to significantly raise the dielectric constant. Further optimization of these processing conditions can further increase performance. These fibers and films have high temperature applications and are viable in applications where the material processing conditions are conducted at high temperature.

### REFERENCES

[A1] C. H. Lee et al. The Journal of Physical Chemistry C, 2012, 116(2), 1798-1804
[A2] Z. Hanif et al., Ind Eng Chem Res, 2023, 62(6), 2662-2670
[A3] S.-W. Jeon et al. Polymers, 2019, 11(4), 582
[A4] C. S. Torres Castillo et al. Nanoscale Adv, 2020, 2(6), 2497-2506
[A5] C. J. Simonsen Ginestra et al., Nat Commun, 2022, 13(1), 3136
[A6] M. Kang et al., Nanomaterials, 2023, 13(18), 2593
[A7] K. Kobashi et al. ACS Appl Nano Mater, 2020, 3(2), 1391-1399
[A8] A. Oseli et al. Macromolecules, 2021, 54(7), 3334-3346
[A9] D. Kim et al., Chemical Communications, 2015, 51(33), 7104-7107
[A10] J. Y. Oh et al., Nano Lett, 2015, 15(1), 190-197
[A11] J. Wang et al., RSC Adv, 2020, 10(32), 18715-18720
[A12] L. Dumée et al. Nanomaterials (Basel), 2013, 3(1), 70-85
[A13] J. S. Walker et al., Small, 2022, 18(11), e2105619
[A14] S. Sharma et al. J Mater Sci, 2017, 52(12), 7503-7515
[A15] C. J. Simonsen Ginestra et al., Nat Commun, 2022, 13(1), 3136
[A16] K. S. Kim et al., ACS Nano, 2014, 8(6), 6211-6220
[A17] Y. Xiao et al. Phys. Rev. B, 2004, 69(20), 205415
[A18] Y. Yue et al., ACS Appl Mater Interfaces, 2024, 16(26), 33971-33980
[A19] C. Zhi et al. Solid State Commun, 2011, 151(2), 183-186
[A20] C. W. Chang et al., Phys. Rev. Lett., 2006, 97(8), 85901
[A21] G. A. Alvarez et al., Appl Phys Lett, 2023, 122(23), 232101
[A22] Y. Hattori et al. ACS Appl Mater Interfaces, 2016, 8(41), 27877-27884
[A23] Y. Hattori et al. ACS Nano, 2015, 9(1), 916-921
[A24] J. S. Walker et al., Nano Lett, 2019, 19(10), 7256-7264
[A25] N. Komatsu et al., Nano Lett, 2020, 20(4), 2332-2338
[A26] X. He et al., Nat Nanotechnol, 2016, 11(7), 633-638

### Example 4—Aramid Nanofiber/Boron Nitride Nanotube Fibers Spun from Binary Alcohol Dispersions

Abstract: Herein, a new method is reported to dispersion process boron nitride nanotube (BNNT)/aramid nanofiber (ANF) into fibers. ANFs are similar to BNNTs in that they are high aspect ratio nanomaterials used to form flexible structure with good dielectric properties and high thermal conductivity. BNNTs and ANFs are dispersed in a solvent that wets the BNNTs (such as IPA), then a second miscible solvent with higher viscosity (such as glycerol) is added. The addition of glycerol provides lubrication for the high aspect ratio nanorod structures, allowing them to detangle and slide with enough mobility to be extruded through small diameter spinnerets. Previous work showed that the dispersion from the binary alcohol solvent mixture shows significantly lower BNNT bundle sizes. ANFs are added to the mix to demonstrate the utility of a composite fiber from this fiber spinning method. Fibers were successfully spun using spinneret diameters as low as 60 μm. These fibers are the first of their kind, and show low mechanical properties of ˜10 MPa strength and ˜3 GPa modulus due to the minimal alignment imparted from spinning alone. Films of these dispersions show good thermal and dielectric performance with thermal conductivity ˜43 W/mK and ˜130 kV/mm dielectric strength. Composites of these high aspect ratio nanomaterials show good performance.

Introduction: Aramids have been utilized in a broad range of electrical [B1-B2], aerospace [B3], and impact applications [B4] due to their mechanical robustness, low density, thermal stability, and electrical insulation. However, the low thermal conductivity (<0.1 W/mK) of aramid fibers cannot remove heat effectively, resulting in more limited applications for the material. The increasing power density of electronics also requires a material with high heat management capability and thermal conductivity. Making aramid fibers and films with a high conductivity filler material can allow for better heat management capability and new applications in high power electronics. High aspect ratio Aramid Nanofibers (ANFs) have been made mainly from mechanical separation [B5] and polymerization-induced self-assembly [B6].

ANFs have similar features to nanotubes. Hydrogen bonding and 71-71 stacking can occur between ANFs and carbon nanotubes (CNTs), leading to a number of works that explore composite CNT/ANF films and fibers. Zhu et al. fabricated CNT/ANF films with 383 MPa strength and 35 GPa modulus [B7]. Luo et al. prepared wet spun CNT/ANF fibers with 6.5 GPa strength and 142 GPa modulus [B8]. These fibers were made by in-situ polymerizing a small amount of functionalized single walled CNTs into an aramid solution and wet spinning into a water/dimethylacetamide coagulant bath. This work also demonstrated that CNTs with good dispersity and alignment significantly improve the crystallinity and orientation degree for a large range of aramid chains.

While ANF/CNT structures can be made, the electrically insulating nature of aramids can be better utilized by pairing with boron nitride nanotubes (BNNTs). BNNTs are electrical insulators with a band gap of 5-6 eV, oxidative resistance up to 900° C. [B9], low-k dielectric properties [B10], high thermal conductivity [B11], and high strength [B12]. This combination of properties makes BNNTs ideal for use in semiconductors, high power electrical cabling, and aerospace structures. While nanotube film production methods have been thoroughly explored [B13-B14], thus far, only two works have effectively employed macro-scale processing methods to produce ordered BNNT fibers. Wet spinning of fibers from a solution of BNNTs in CSA [B14] and direct formation of fibers from the BNNT plume after synthesis [B15] have produced BNNT fibers with properties around 10 MPa strength and 1 GPa modulus.

Wet spinning appears most easily adapted to processing BNNTs because of its flexibility with type of synthesis method and allows for further processing of BNNTs to higher purity. However, due to the hazards associated with handling of CSA, there are many equipment- and safety-related issues associated with its commercialization. The work herein above was the first to demonstrate the utility of high viscosity solvent mixtures to disperse BNNTs without surfactant or sonication. The method reported herein above does not require hazardous solvents, sonication, or polymer surfactants to process boron nitride nanotubes (BNNT) from dispersions into macrostructures such as fibers and films. This work shows that ANF/BNNT composite macrostructures can be made using the reported dispersion method.

### Experimental

Materials: Boron nitride nanotubes were obtained from BNNT, LLC. Isopropanol, ethanol, and glycerol were used as-received from Sigma Aldrich. Aramid nanofibers were synthesized at NASA Glenn Research Center.

Processing: BNNT dispersions in alcohol/glycerol solvent mixtures were made by first adding a measured weight of BNNTs and ANFs to the alcohol and stirring at high rpm. This was left to mix for at least 1 hr before adding glycerol slowly while maintaining stirring. The alcohol/glycerol nanotube dispersion was then stirred overnight. The dispersions made here for both fibers and films used solid contents of ˜55 wt % BNNTs and ˜45 wt % ANFs in 0.5 mL IPA and 13.5 mL glycerol.

To yield a spinnable dispersion, the ANF/BNNT dispersions were concentrated using centrifuge. The dispersions were centrifuged in 1 hr intervals at 8000 RCF, repeated 4 times. Excess solvent was removed to concentrate the nanotubes in the glycerol component. These highly-concentrated dispersions were then added to a 3 mL syringe and extruded through the syringe tip of choice. Syringe spinning down to 60 μm diameter was successful, and fibers were spun continuously by syringe with circular syringe tips of 210 and 260 μm diameter. The syringe spinning was performed onto a spool rotating in a “coagulation” bath of 100% DIW. The wet fibers were then vacuum dried on the spool to remove any excess solvent before tensile testing. This process formed large diameter fibers that maintained their shape and good mechanical robustness after extrusion and drying.

Films were created by adding the as-made solvent mixture dispersions into a reservoir connected to a filter and vacuum pump, where the dispersion is slowly pulled through the filter to leave the ANF/BNNTs as a self-supporting film. ANF/BNNT films were made by filtering the BNNT dispersions with a Teflon 0.22 μm pore filter placed over a frit that is connected to a vacuum pump. After vacuuming out the solvent, films were washed with 200 mL of methanol and 200 mL of de-ionized water (DIW). Any remaining solvent was removed by heating the films to 100° C. under vacuum for 2 hours.

Characterization: Density was estimated by weighing the sample and estimating volume of a thin cylinder from the diameter and measured thickness using a micrometer with 0.25-inch diameter plates. The morphology and chemical composition of the films and fibers were captured using a Hitachi SU8230 SEM equipped with an Oxford energy-dispersive X-ray spectroscopy (EDS) detector. Transmission Electron Microscopy (TEM) was performed at NASA Glenn Research Center after sample preparation using Focus Ion Beam (FIB) milling. TEM foils were FIB milled out from the fibers using a ZEISS Auriga dual focused ion beam 40 FIB-SEM with a Ga ion source. FEI Talos F200S Scanning/Transmission Electron Microscope was then used for microstructural analysis and high-resolution imaging and characterization.

Additional chemical analysis was performed using Fourier Transform Infrared Spectroscopy (FTIR) was performed using a Nicolet 6700 FT-IR with diamond crystal Attenuated Total Reflectance attachment. Thermal and dielectric property characterization was performed at NASA Glenn Research Center. For heat capacity, the value was estimated to be ˜1.12 J/g/K based on the 55/45 wt % ratio of BNNTs/ANF in the film and fibers. Thermal diffusivity measurements were performed at room temperature using an in-plane mask on a NETZSCH Nanoflash 447 Laser Flash Apparatus (LFA). Thermal conductivity was estimated by multiplying the LFA diffusivity by the film density and heat capacity. Dielectric breakdown was performed in silicone oil using AC voltage applied at 0.6 kV/s using an Eaton High Voltage Test Setup. For thermal conductivity and dielectric breakdown, 0.5-inch circular samples were used. The dielectric constant was studied using an Agilent 4294A Precision Impedance Analyzer using a frequency sweep of the capacitance from 100 Hz to 100 MHz. For dielectric spectroscopy, circular samples were pressed between copper foil 0.25-inch in diameter.

Results: Earlier work using CNTs from Kobashi et al. showed that viscous liquids such as glycerol and silicone oil can reduce CNT aggregate size and straighten inhomogeneous bundles into long and thin strands by increasing shear on the nanotube aggregates [B16]. Similarly, work by Wang et al. used glycerol and heat to facilitate slippage of the CNT connection points, resulting in higher alignment of the CNTs in a fiber structure [B17]. The polarity-driven shear transfer behavior of glycerol and the viscosity-driven softening of nanotube connections form the basis of work on BNNT dispersions that demonstrates this method. Similar to increasing the glycerol temperature, adding a second solvent with similar polarity, such as a monofunctional alcohol, to glycerol will lower the viscosity and enable slippage of the nanotube connections. When the major component of the final dispersion is glycerol, the high viscosity of the dispersion prevents the BNNT bundles from re-entangling.

The aforementioned shear transfer and connection-softening properties allow for IPA/glycerol dispersions of BNNTs to readily form films and fibers. In a typical process, ANFs and BNNTs were added to isopropyl alcohol (IPA), mechanically stirred to break up agglomerates, then glycerol was added slowly while stirring (1400 rpm). ANF/BNNT fibers were made utilizing a dry-jet wet spinning approach and highly concentrated ANF/BNNT dispersions. High concentrations were achieved by centrifuging the dispersion multiple times and removing excess solvent, allowing the dispersion to reach a spinnable viscosity and without long solvent evaporation times. Additionally, this high concentration maintains its integrity during air-gap spinning. This work utilizes the air-gap to maximize alignment and performance without post-spinning stretching or drawing.

In the dispersion, ANFs and BNNTs, move past one another and form moderately aligned fibers that maintain their shape and structure after extrusion onto a spool (FIG. 26A) and washed in a methanol bath (FIG. 26B). These fibers were dried and were found to be self-supporting (FIG. 26C). There are no previous reports of ANF/BNNT fibers, and the only other published work to spin BNNT fibers relied on chlorosulfonic acid to dissolve and individualize BNNTs prior to spinning [B18]. The capability of spinning these fibers without chlorosulfonic acid, other polymer surfactant, or even sonication represents a significant advancement in the dispersion-processing of high aspect ratio nanomaterials like ANFs and BNNTs. Also, there is a capability to spin ANF in these binary alcohol dispersions into fibers, which can offer an additional advantage over existing methods involving aramid fiber spinning in acid.

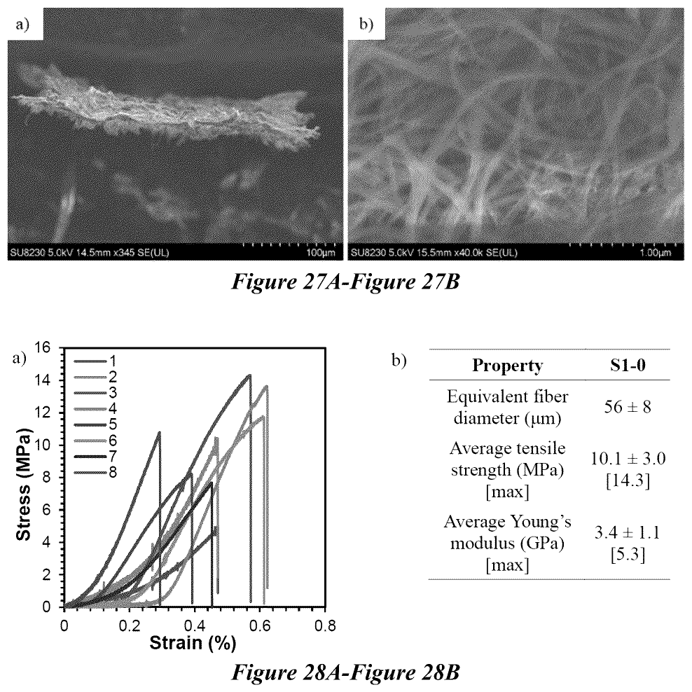

The obtained fibers have a flat cross-section (FIG. 27A), due to the fiber drying on the spool and flattening, and equivalent diameter of 56±8 μm. The BNNTs and ANFs entangle and generate a homogenous microstructure of high aspect ratio nanofibers and nanotubes (FIG. 27B). The interaction between ANF and BNNT result in good mechanical integrity for a fiber that has undergone no post-process stretching to improve alignment.

The produced fibers were imaged and tensile tested at 25.4 mm gauge length to measure the mechanical properties (FIG. 28A). The produced ANF/BNNT fibers are not high-performance because they were spun at a draw ratio of 1× and no post-spin drawing was conducted. Although these fibers do not show significant orientation with the fiber axis, improving the ANF and BNNT alignment within the fiber through higher drawing and tensioning is known to produce better mechanical properties. These fibers were made to demonstrate spinnability. While the tensile performance of these fibers has not been optimized, their properties are similar to neat BNNT fibers spun from CSA [B18]. The ANF/BNNT fibers show an average tensile strength of 10.1±3.0 MPa and modulus of 3.4±1.1 GPa recorded at 25.4 mm gauge length (FIG. 28B). This is comparable to neat BNNT fibers from CSA that recorded strength of 16 MPa and modulus of 1.5 GPa at 4 mm gauge length.

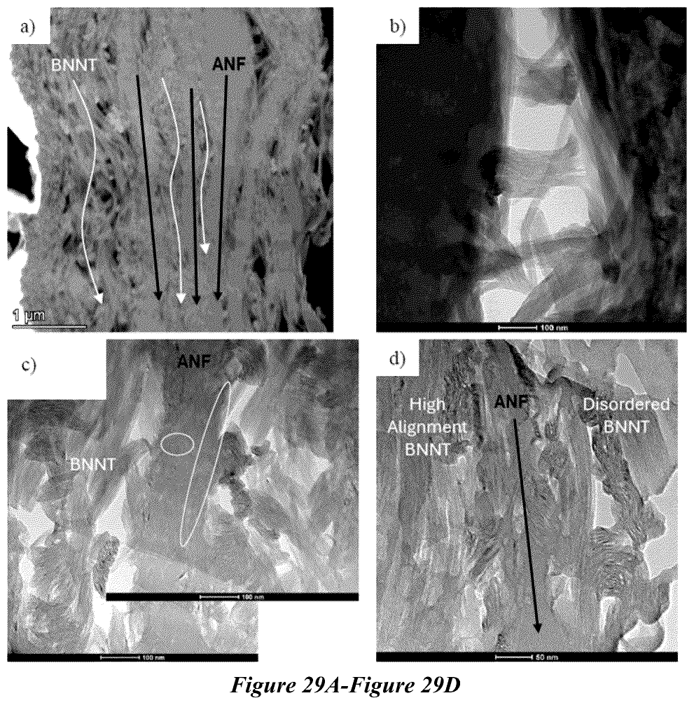

The structure of these fibers was examined in TEM after FIB milling to ˜100 Å to produce thin samples (FIG. 29A-FIG. 29D). The BNNTs and ANFs form a unique sandwich structure along the fiber length. Zhao et al. observed a similar structure in ANF/BN NanoSheet (BNNS) composites and reported it as a “brick and mortar” structure of BNNS bricks with ANF mortar interwoven with the bricks [B19]. While the ANFs are known to have 8-20 nm individual diameters, BNNTs most commonly show a double-walled tube structure with diameter of ˜3 nm. Both ANFs and BNNTs have micron-scale lengths. When solvent is removed and the fibers are dried, ANFs appear to coalesce into fibrils of ˜100 nm diameter while the BNNTs appear to form smaller bundles ˜20 nm in diameter. The ANF/BNNT structure shows that ANFs form continuous fibrils throughout the BNNT structure, where BNNT bundles tend to fill gaps between ANF fibrils (FIG. 29A). Similar to earlier work on BNNT fibers from PAN/BNNT, ˜20 nm diameter bundles form from the coalescence and aligning of 10-30 individual BNNTs (FIG. 29B). In the studied ANF/BNNT structure, these bundles do not appear to align in a predominant direction, but the individual BNNTs are highly aligned with each other in the bundle. Additionally, BNNTs bridge large spaces within the fiber and intertwine directly with ANFs within the ANF fibril and on the fibril surface (FIG. 29B and FIG. 29C). The distance between the ANF fibrils appear to have an impact on the BNNT alignment within the fiber (FIG. 29D). More space between fibrils causes less confinement effects to occur and the BNNTs exhibit less orientation along the fibril length. Smaller separation between fibrils confines the BNNTs and create a finer microstructure. A coarse microstructure results from larger spacing, with less confining effects on the BNNT bundles.

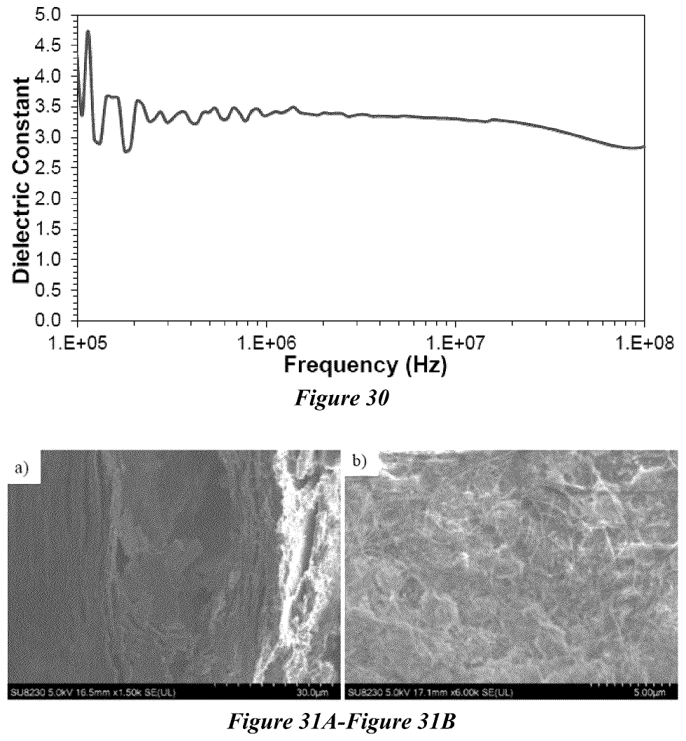

Transport properties of the composite system were tested by making ANF/BNNT films from IPA/glycerol dispersions. The thermal conductivity, dielectric breakdown, and dielectric permittivity of these films were tested to better understand the performance and application of the material. Table 5 details the properties of these films. Dielectric breakdown of ˜130 kV/mm make the film highly insulating and suitable for high voltage applications. Dielectric constant in the range of 2.8-3.4 gives good signal transparency (FIG. 30). The ANF/BNNT films have a thermal diffusivity of 45±9 mm²/s, theoretical heat capacity of 1.12 J/g/K, and density of 0.85±0.04 g/cm³, yielding a thermal conductivity of 43±9 W/mK. Additionally, from the inclusion of BNNTs, the thermal conductivity goes from <0.1 W/mK for neat ANF to ˜43 W/mK for the composite film containing ˜55 wt % BNNTs. These films have better thermal conductivity but lower dielectric performance compared to ANF/PEI/BNNT films made by Zhao et al., which recorded ˜10 W/mK thermal conductivity and 412 kV/mm dielectric breakdown [1B20]. The ANF/PEI/BNNT films had higher dielectric performance likely because they contained polymer that lowered porosity and were hot-pressed to a higher density of 1.2-1.3 g/cm³.

TABLE 5
S2 ANF/BNNT film properties

| | Dielectric | Dielectric | | Thermal |
|---|---|---|---|---|
| | Constant | Breakdown | Density | Conductivity |
| Sample | (at 1 MHz) | (kV/mm) | (g/cm³) | (W/mK) |
| S2 | 3.4 ± 0.1 | 129.5 ± 5.9 | 0.85 ± 0.04 | 43 ± 9 |

Imaging was collected of the conducting cavities of the films after breakdown to better understand the material behavior. Cross-sections (FIG. 31A) of the breakdown pit show a delaminated film structure following breakdown. Additionally, melted and oxidized nodules are seen around the cavity along with BNNTs (FIG. 31B). The presence of high aspect ratio nanomaterials make the ANF/BNNT films very robust, as local failures do not necessarily compromise the total part integrity. From this perspective, the ANF/BNNT films are similar to neat BNNT films, possessing the thermal and dielectric properties of BN ceramics with the mechanical behavior and plasticity of polymeric films.

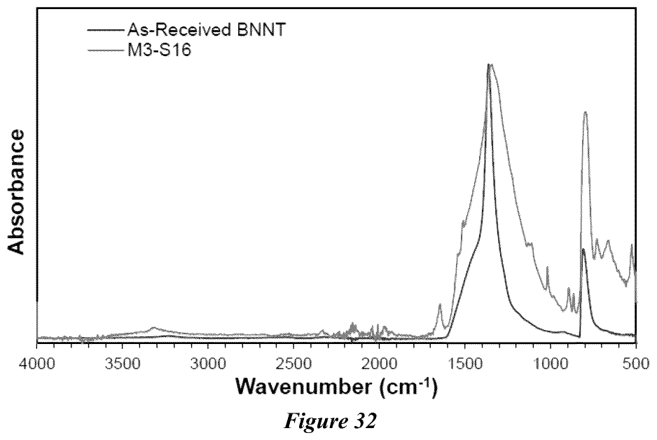

FTIR of the fibers was performed, showing the ANF presence and dominant signal of BNNTs (FIG. 32). Peaks at ˜800 cm⁻¹ and ˜1360 cm⁻¹ correspond to B-N out-of-plane buckling and in-plane optical phonon modes, respectively. ANF peaks appear at ˜3300 cm⁻¹ (−NH, derived from hydrogen bond association state), ˜1640 cm⁻¹ (stretching vibration of —C═O), ˜1540 cm⁻¹ (curved vibration of —N—H), and ˜1300 cm⁻¹ (bending vibration of —N—H).

Conclusions: These hybrid fibers show the possibilities for creation of multiple types of functional fibers from the same base BNNT fiber products. ANF/BNNT fibers were made to demonstrate the utility of using the IPA/glycerol dispersion and spinning method with other types of high aspect ratio nanomaterials. ANFs are similar in structure to BNNTs and ANF/BNNT films were shown to have flexibility, good dielectric performance, and high thermal conductivity. BNNTs and ANFs are dispersed in IPA and the viscosity of the dispersion is increased by adding glycerol. The addition of glycerol provides lubrication for the high aspect ratio nanorod structures, allowing them to slide with enough mobility to be extruded through small diameter spinnerets. Fibers were successfully spun using spinneret diameters as low as 60 μm. These fibers are the first of their kind, and show low mechanical properties of ˜10 MPa strength and ˜3 GPa modulus due to the minimal alignment imparted from spinning alone. Films of these dispersions show good thermal and dielectric performance with thermal conductivity ˜43 W/mK and ˜130 kV/mm dielectric strength. Composites of these high aspect ratio nanomaterials show good performance.

### REFERENCES

[B1] F. Zeng et al. ACS Nano, 2020, 14(1), 611-619
[B2] L. Liu et al., Nano Energy, 2020, 69, 104398
[B3] Y. Hu et al., ACS Nano, 2022, 16(4), 5984-5993
[B4] Y. Li et al. Compos B Eng, 2022, 238, 109890
[B5] S. Ifuku et al. RSC Adv, 2014, 4(76), 40377-40380
[B6] H. Yan et al. RSC Adv, 2016, 6(32), 26599-26605
[B7] J. Zhu et al. ACS Nano, 2015, 9(3), 2489-2501
[B8] J. Luo et al., Nat Commun, 2023, 14(1), 3019
[B9] N. Kostoglou et al., Nanomaterials (Basel), 2020, 10(12), 2435.
[B10] X. Hong et al. J Electron Mater, 2016, 45(1), 453-461
[B11] Y. Xiao et al. Phys Rev B, 2004, 69(20), 205415
[B12] X. Wei et al. Advanced Materials, 2010, 22(43), 4895-4899
[B13] J. S. Walker et al., Small, 2022, 18(11), e2105619
[B14] C. J. Simonsen Ginestra et al., Nat Commun, 2022, 13(1), 3136
[B15] K. S. Kim et al., ACS Nano, 2014, 8(6), 6211-6220
[B16] K. Kobashi et al. ACS Appl Nano Mater, 2020, 3(2), 1391-1399
[B17] J. Wang et al., RSC Adv, 2020, 10(32), 18715-18720
[B18] C. J. Simonsen Ginestra et al., Nat Commun, 2022, 13(1), 3136
[B19] L.-H. Zhao et al., Polymers, 2021, 13(13), 2028
[B20] L. Zhao et al., Mater Des, 2021, 210, 110124

Other advantages which are obvious, and which are inherent to the invention will be 20 evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as 25 illustrative and not in a limiting sense.

The methods and compositions of the appended claims are not limited in scope by the specific methods and compositions described herein, which are intended as illustrations of a few aspects of the claims and any methods and compositions that are functionally equivalent are intended to fall within the scope of the claims. Various modifications of the methods and 30 compositions in addition to those shown and described herein are intended to fall within the scope of the appended claims. Further, while only certain representative method steps disclosed herein are specifically described, other combinations of the method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

### EXEMPLARY ASPECTS

In view of the described compositions, devices, systems, and methods, herein below are described certain more particularly described aspects of the inventions. The particularly recited aspects should not, however, be interpreted to have any limiting effect on any different claims containing different or more general teachings described herein or that the “particular” aspects are somehow limited in some way other than the inherent meanings of the language and formulas literally used therein.

Example 1: A method of making a high aspect ratio nanomaterial dispersion (e.g., a dispersion comprising a high aspect ratio nanomaterial), the method comprising: dispersing the high aspect ratio nanomaterial in a first solvent, thereby forming a preliminary dispersion; and adding a second solvent to the preliminary dispersion to thereby form the high aspect ratio nanomaterial dispersion, wherein the second solvent has a higher viscosity than the first solvent and is miscible with the first solvent; wherein the first solvent and the second solvent are each independently a low-impact solvent.

Example 2: The method of any example herein, particularly example 1, wherein the high aspect ratio nanomaterial comprises a nanotube, such as a plurality of nanotubes.

Example 3: The method of any example herein, particularly examples 1-2, wherein the high aspect ratio nanomaterial comprises boron nitride nanotubes, aramid nanofibers, or a combination thereof.

Example 4: The method of any example herein, particularly examples 1-3, wherein the high aspect ratio nanomaterial comprises boron nitride nanotubes.

Example 5: The method of any example herein, particularly examples 1-4, wherein the high aspect ratio nanomaterial comprises boron nitride nanotubes and aramid nanofibers.

Example 6: A method of making a boron nitride nanotube dispersion (e.g., a dispersion comprising boron nitride nanotubes), the method comprising: dispersing a plurality of boron nitride nanotubes (BNNTs) in a first solvent, thereby forming a preliminary dispersion; and adding a second solvent to the preliminary dispersion to thereby form the boron nitride nanotube dispersion, wherein the second solvent has a higher viscosity than the first solvent and is miscible with the first solvent; wherein the first solvent and the second solvent are each independently a low-impact solvent.

Example 7: The method of any example herein, particularly example 6, wherein the dispersion further comprises a second high aspect ratio nanomaterial.

Example 8: The method of any example herein, particularly example 6 or example 7, wherein the dispersion further comprises a plurality of aramid nanofibers.

Example 9: The method of any example herein, particularly examples 1-8, wherein the first solvent comprises an alcohol.

Example 10: The method of any example herein, particularly examples 1-9, wherein the first solvent comprises a C1-C4 alcohol.

Example 11: The method of any example herein, particularly examples 1-10, wherein the first solvent comprises methanol, ethanol, n-propanol, isopropanol, n-butanol, isobutanol, sec-butanol, tert-butanol, or a combination thereof.

Example 12: The method of any example herein, particularly examples 1-11, wherein the first solvent comprises isopropanol.

Example 13: The method of any example herein, particularly examples 1-12, wherein the second solvent comprises ethylene glycol, propylene glycol, glycerol, or a combination thereof.

Example 14: The method of any example herein, particularly examples 1-13, wherein the second solvent comprises glycerol.

Example 15: The method of any example herein, particularly examples 1-14, wherein the first solvent comprises a C1-C4 alcohol and the second solvent comprises glycerol.

Example 16: The method of any example herein, particularly examples 1-15, wherein the first solvent comprises isopropanol and the second solvent comprises glycerol.

Example 17: The method of any example herein, particularly examples 1-16, wherein the dispersion comprises from 1 to 99.9 vol % of the second solvent, relative to the total volume of the dispersion.

Example 18: The method of any example herein, particularly examples 1-17, wherein the dispersion comprises from 10 to 60 vol % of the second solvent, relative to the total volume of the dispersion.

Example 19: The method of any example herein, particularly examples 1-18, wherein the dispersion comprises 50 vol % or more of the second solvent, relative to the total volume of the dispersion.

Example 20: The method of any example herein, particularly examples 1-19, wherein the first solvent comprises a C1-C4 alcohol, the second solvent comprises glycerol, and the dispersion comprises from 10 to 60 vol % of the second solvent, relative to the total volume of the dispersion.

Example 21: The method of any example herein, particularly examples 1-20, wherein the first solvent comprises isopropanol, the second solvent comprises glycerol, and the dispersion comprises from 10 to 60 vol % of the second solvent, relative to the total volume of the dispersion.

Example 22: The method of any example herein, particularly examples 1-21, wherein the first solvent comprises isopropanol, the second solvent comprises glycerol, and the dispersion comprises 50 vol % or more of the second solvent, relative to the total volume of the dispersion.

Example 23: The method of any example herein, particularly examples 1-22, wherein the dispersion comprises from greater than 0 to 20 wt. % of the high aspect ratio nanomaterial, relative to the total weight of the dispersion.

Example 24: The method of any example herein, particularly examples 1-23, wherein the dispersion comprises from greater than 0 to 1 wt. % of the high aspect ratio nanomaterial, relative to the total weight of the dispersion.

Example 25: The method of any example herein, particularly examples 1-24, wherein the dispersion comprises from 0.001 to 0.5 wt. % of the high aspect ratio nanomaterial, relative to the total weight of the dispersion.

Example 26: The method of any example herein, particularly examples 1-25, wherein the first solvent comprises isopropanol, the second solvent comprises glycerol, the dispersion comprises 50 vol % of the second solvent or more, relative to the total volume of the dispersion, and the dispersion comprises from 0.001 to 0.5 wt. % of the high aspect ratio nanomaterial.

Example 27: The method of any example herein, particularly examples 1-26, wherein the high aspect ratio nanomaterial comprises a plurality of boron nitride nanotubes (BNNTs) and the dispersion comprises from greater than 0 to 20 wt. % of the BNNTs, relative to the total weight of the dispersion.

Example 28: The method of any example herein, particularly example 27, wherein the dispersion comprises from greater than 0 to 1 wt. % of BNNTs, relative to the total weight of the dispersion.

Example 29: The method of any example herein, particularly examples 27-28, wherein the dispersion comprises from 0.001 to 0.5 wt. % of BNNTs, relative to the total weight of the dispersion.

Example 30: The method of any example herein, particularly examples 1-29, wherein the high aspect ratio nanomaterial comprises a plurality of boron nitride nanotubes (BNNTs), the first solvent comprises isopropanol, the second solvent comprises glycerol, the dispersion comprises 50 vol % of the second solvent or more, relative to the total volume of the dispersion, and the dispersion comprises from 0.001 to 0.5 wt. % of BNNTs.

Example 31: The method of any example herein, particularly examples 1-30, wherein the method, preliminary dispersion, and dispersion are substantially free of polymer surfactants.

Example 32: The method of any example herein, particularly examples 1-31, wherein the method, preliminary dispersion, and dispersion are substantially free of dimethyl formamide (DMF), dimethyl acetamide (DMAc), dimethyl propylene urea (DMPU), chlorosulfonic acid (CSA), Pluronic surfactants, or a combination thereof.

Example 33: The method of any example herein, particularly examples 1-32, wherein the method, preliminary dispersion, and dispersion are substantially free of dimethyl formamide (DMF), dimethyl acetamide (DMAc), dimethyl propylene urea (DMPU), Pluronic surfactants, and chlorosulfonic acid (CSA).

Example 34: The method of any example herein, particularly examples 1-33, wherein the method is substantially free of sonication.

Example 35: The method of any example herein, particularly examples 1-33, wherein the method minimizes the impact of sonication.

Example 36: The method of any example herein, particularly examples 1-35, wherein the dispersing comprises stirring the high aspect ratio nanomaterial in the first solvent, and wherein the second solvent is subsequently added during stirring.

Example 37: The method of any example herein, particularly examples 1-36, wherein the high aspect ratio nanomaterial comprises a plurality of boron nitride nanotubes and the dispersing comprises stirring the plurality of boron nitride nanotubes in the first solvent, and wherein the second solvent is subsequently added during stirring.

Example 38: The method of any example herein, particularly examples 1-37, wherein the method further comprises processing the dispersion to make a macrostructure comprising the high aspect ratio nanomaterial.

Example 39: The method of any example herein, particularly examples 1-38, wherein the high aspect ratio nanomaterial comprises a plurality of boron nitride nanotubes and the method further comprises processing the dispersion to make a boron nitride nanotube macrostructure (e.g., a macrostructure comprising boron nitride nanotubes).

Example 40: The method of any example herein, particularly example 38 or example 39, wherein the macrostructure comprises a film, a fiber, a 3D printed structure, or a combination thereof.

Example 41: The method of any example herein, particularly examples 38-40, wherein the macrostructure comprises a fiber.

Example 42: The method of any example herein, particularly example 41, wherein the method further comprises spinning and/or extrusion to form the fiber.

Example 43: The method of any example herein, particularly example 41 or example 42, wherein the method further comprises extruding the dispersion through an extrusion device (e.g., syringe) into a coagulation bath to form the fiber.

Example 44: The method of any example herein, particularly examples 42-43, wherein the dispersion is spun using a spinneret having a diameter of 500 micrometers or less, or 410 micrometers or less, such as 60 micrometers.

Example 45: The method of any example herein, particularly examples 42-44, wherein the method further comprises concentrating one or more components of the dispersion prior to extrusion.

Example 46: The method of any example herein, particularly example 45, wherein the method further comprises centrifuging the dispersion prior to extrusion.

Example 47: The method of any example herein, particularly examples 41-46, wherein the fiber has an average outer diameter of from 100 nm to 1 millimeter, from 100 nm to 100 μm, or from 10 to 25 μm.

Example 48: The method of any example herein, particularly examples 41-47, wherein the method further comprises drying the fiber.

Example 49: The method of any example herein, particularly examples 41-48, wherein the method further comprises stretching the fiber.

Example 50: The method of any example herein, particularly examples 38-40, wherein the macrostructure comprises a film.

Example 51: The method of any example herein, particularly example 50, wherein the method comprises forming the film by casting, filtration, extrusion, or a combination thereof.

Example 52: The method of any example herein, particularly example 50 or any example herein, particularly example 51, wherein the method comprises filtering by applying negative pressure (e.g., vacuum).

Example 53: The method of any example herein, particularly examples 50-52, wherein the film has an average thickness of from 100 nanometers to 1 millimeter, from 100 nm to 100 μm, or from 5 to 10 μm.

Example 54: The method of any example herein, particularly examples 50-53, wherein the method further comprises drying the film.

Example 55: The method of any example herein, particularly examples 50-54, wherein the method further comprises stretching and/or pressing the film.

Example 56: The method of any example herein, particularly examples 38-40, wherein the macrostructure comprises a 3D printed structure.

Example 57: The method of any example herein, particularly example 56, wherein the method comprises 3D printing.

Example 58: The method of any example herein, particularly examples 38-57, wherein the method further comprises drying the macrostructure.

Example 59: The method of any example herein, particularly examples 38-58, wherein the method further comprises stretching and/or pressing the macrostructure.

Example 60: The method of any example herein, particularly examples 38-59, wherein the method further comprises heat treating the macrostructure.

Example 61: The method of any example herein, particularly examples 38-60, wherein the method further comprises removing at least a portion of the first solvent from the dispersion prior to the processing, e.g., prior to the extrusion.

Example 62: The method of any example herein, particularly examples 38-61, wherein the macrostructure is stable in an oxygen environment at a temperature of 900° C. or less and/or in an inert environment at a temperature of 2000° C. or less.

Example 63: The method of any example herein, particularly examples 38-62, wherein the macrostructure has a high thermal conductivity, high temperature oxidative resistance, low electrical conductivity, or a combination thereof.

Example 64: A macrostructure made by the method of any example herein, particularly examples 38-63.

Example 65: The macrostructure of any example herein, particularly example 64, wherein the macrostructure is free-standing and/or self-supporting.

Example 66: A method of use of the macrostructure of any example herein, particularly examples 64-65.

Example 67: An article of manufacture comprising the macrostructure of any example herein, particularly examples 64-65.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

The compositions and methods of the appended claims are not limited in scope by the specific compositions methods described herein, which are intended as illustrations of a few aspects of the claims and any compositions methods that are functionally equivalent are intended to fall within the scope of the claims. Various modifications of the compositions and methods in addition to those shown and described herein are intended to fall within the scope of the appended claims. Further, while only certain representative method steps disclosed herein are specifically described, other combinations of the method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

What is claimed is:

1. A method of making a dispersion comprising a high aspect ratio nanomaterial, the method comprising:
dispersing the high aspect ratio nanomaterial in a first solvent, thereby forming a preliminary dispersion; and
adding a second solvent to the preliminary dispersion to thereby form the high aspect ratio nanomaterial dispersion, wherein the second solvent has a higher viscosity than the first solvent and is miscible with the first solvent;
wherein the first solvent and the second solvent are each independently a low-impact solvent.

2. The method of claim 1, wherein the high aspect ratio nanomaterial comprises boron nitride nanotubes, aramid nanofibers, or a combination thereof.

3. The method of claim 1, wherein the high aspect ratio nanomaterial comprises boron nitride nanotubes.

4. The method of claim 1, wherein the high aspect ratio nanomaterial comprises boron nitride nanotubes and aramid nanofibers.

5. The method of claim 1, wherein the first solvent comprises an alcohol.

6. The method of claim 1, wherein the first solvent comprises a C1-C4 alcohol.

7. The method of claim 1, wherein the first solvent comprises methanol, ethanol, n-propanol, isopropanol, n-butanol, isobutanol, sec-butanol, tert-butanol, or a combination thereof.

8. The method of claim 1, wherein the first solvent comprises isopropanol.

9. The method of claim 1, wherein the second solvent comprises ethylene glycol, propylene glycol, glycerol, or a combination thereof.

10. The method of claim 1, wherein the second solvent comprises glycerol.

11. The method of claim 1, wherein the dispersion comprises from 1 to 99.9 vol % of the second solvent, relative to the total volume of the dispersion.

12. The method of claim 1, wherein the dispersion comprises from 50 to 99.9 vol % of the second solvent, relative to the total volume of the dispersion.

13. The method of claim 1, wherein the dispersion comprises from greater than 0 to 20 wt. % of the high aspect ratio nanomaterial, relative to the total weight of the dispersion.

14. The method of claim 1, wherein the dispersion comprises from greater than 0 to 1 wt. % of the high aspect ratio nanomaterial, relative to the total weight of the dispersion.

15. The method of claim 1, wherein the method, preliminary dispersion, and dispersion are substantially free of polymer surfactants.

16. The method of claim 1, wherein the method, preliminary dispersion, and dispersion are substantially free of dimethyl formamide (DMF), dimethyl acetamide (DMAc), dimethyl propylene urea (DMPU), chlorosulfonic acid (CSA), and Pluronic surfactants, or a combination thereof.

17. The method of claim 1, wherein the method is substantially free of sonication.

18. The method of claim 1, wherein the method further comprises processing the dispersion to make a macrostructure comprising the high aspect ratio nanomaterial.

19. The method of claim 18, wherein the macrostructure comprises a film, a fiber, a 3D printed structure, or a combination thereof.

20. A macrostructure made by the method of claim 18, wherein the macrostructure is free-standing and/or self-supporting.
